(19) United States
(12) Patent Application Publication
(10) Pub. No.: US 2013/0268724 A1
(43) Pub. Date: Oct. 10, 2013

(54) SSD WITH RAID CONTROLLER AND PROGRAMMING METHOD

(71) Applicants: Man-Keun Seo, Hwaseong-Si (KR); Eun-Chu Oh, Hwaseong-Si (KR); Hong-Rak Son, Anyang-Si (KR); Jun-Jin Kong, Yongin-Si (KR)

(72) Inventors: Man-Keun Seo, Hwaseong-Si (KR); Eun-Chu Oh, Hwaseong-Si (KR); Hong-Rak Son, Anyang-Si (KR); Jun-Jin Kong, Yongin-Si (KR)

(21) Appl. No.: 13/828,138

(22) Filed: Mar. 14, 2013

(30) Foreign Application Priority Data
Apr. 9, 2012 (KR) 10-2012-0036509

(51) Int. Cl. G06F 12/02

(52) U.S. Cl. CPC G06F 12/0246
USPC 711/103

(57) ABSTRACT

A solid state drive (SSD) includes non-volatile memory devices and a RAID controller. Each of the non-volatile memory devices includes a memory cell array having a plurality of physical pages. The RAID controller performs a parity operation on 1st through (N−1)th physical page data to generate Nth physical page data, determines a physical page group including 1st through Nth physical pages that are selected from the 1st through Nth non-volatile memory devices, respectively, such that at least two of the 1st through Nth physical pages have different bit error rates from each other, and stores the 1st through Nth physical page data in the 1st through Nth physical pages, respectively.

### CROSS-REFERENCE TO RELATED APPLICATION(S)

This application claims priority under 35 USC §119 to Korean Patent Application No. 10-2012-0036509 filed on Apr. 9, 2012, the subject matter of which is hereby incorporated by reference.

### BACKGROUND

Embodiments of the inventive concept relate to solid state drive(s) (SSD), and more particularly, to SSD having a redundant array of independent disks (RAID) architecture.

Hard disk drive(s) (HDD) have historically been used as a data storage mechanism(s) in many different type of electronic devices. Recently, however, HDD have been replaced by SSD. Unlike HDD, SSD have no moving mechanical parts, but instead are implemented with a plurality of nonvolatile memory devices (e.g., flash memory devices).

SSD enjoy many advantages over HDD. For example, due to the absence of moving mechanical parts, SSD do not generate heat and noise like HDD. In addition, SSD generally provide faster access rates, higher data storage density, and increased stability.

More recently, SSD have been provide with a redundant array of independent disks (RAID) architecture to further increase operating speed and stability. SSD having a RAID architecture usually include a plurality of flash memory devices, and input data is distributed over the plurality of flash memory devices. SSD having a RAID architecture is able to increase operating speed by accessing the plurality of flash memory devices in parallel (or simultaneously). In addition, SSD having a RAID architecture are able to store parity data along with input data. Therefore, although physical errors occur during the writing of data to and/or reading of data from the plurality of flash memory devices, SSD having a RAID architecture are able to recover errant (or “damaged”) data using the co-stored parity data. As such, SSD having a RAID architecture offer increased data reliability or stability.

Unfortunately, different physical pages of the various flash memory devices operate with different error rates. Therefore, the data recovery rate of a particular SSD having a RAID architecture will vary in accordance with the physical pages of the plurality of flash memory devices. As such, stability of a SSD having a RAID architecture will often be determined by the lowest (worst) data recovery rate among a plurality of data recovery rates respectively associated with different physical pages of the plurality of flash memory devices.

### SUMMARY

Certain embodiments of the inventive concept provide a solid state drive (SSD) having a RAID architecture with increased overall data recovery rates. Other embodiments of the inventive concept provide an electronic device including this type of SSD.

According to certain embodiments of the inventive concept, a solid state drive (SSD) is provided that includes; 1st through Nth non-volatile memory devices each including a memory cell array, the memory cell array including a plurality of physical pages, and a redundant array of independent disks (RAID) controller configured to perform a parity operation on 1st through (N−1)th physical page data to generate Nth physical page data, determine a physical page group including 1st through Nth physical pages respectively selected from the 1st through Nth non-volatile memory devices, such that at least two of the 1st through Nth physical pages have different bit error rates, and store the 1st through Nth physical page data in the 1st through Nth physical pages, respectively.

According to certain embodiments of the inventive concept, a solid state drive (SSD) is provided that includes; 1st through Nth non-volatile memory devices, each including a memory cell array, each memory cell array including a plurality of physical pages, and each of the plurality of physical pages including first level through Mth level logical pages, where N and M are each integers greater than one, and a redundant array of independent disks (RAID) controller configured to perform a parity operation on 1st through (N−1)th logical page data to generate Nth logical page data, determine a physical page group including 1st through Nth physical pages respectively selected from the 1st through Nth non-volatile memory devices, determine a logical page group including 1st through Nth logical pages respectively selected from the 1st through Nth physical pages, such that at least two of the 1st through Nth logical pages are of different levels, and store the 1st through Nth logical page data in the 1st through Nth logical pages, respectively.

According to certain embodiments of the inventive concept, a method of programming a solid state drive (SSD) is provided that includes; generating 1st through the (N−1)th physical page data by buffering data received from a host, generating an Nth physical page data by performing the parity operation on the 1st through the (N−1)th physical page data, determining a physical page group to include the 1st through Nth physical pages, such that at least two of the 1st through Nth physical pages have different bit error rates, and storing the 1st through Nth physical page data in 1st through Nth physical pages of a memory cell array, respectively.

### BRIEF DESCRIPTION OF THE DRAWINGS

Illustrative, non-limiting embodiments of the inventive concept (hereafter, collectively and individually, “example embodiments”) will be described hereafter with reference to the accompanying drawings.

FIG. 1 is a block diagram illustrating a solid state drive (SSD) according to example embodiments.

FIG. 2 is a block diagram illustrating an example of a non-volatile memory device included in the SSD of FIG. 1.

FIG. 3 is a perspective view illustrating an example of a memory block included in a three-dimensional flash memory cell array of FIG. 2.

FIG. 4 is a cross-sectional view taken along line I-I′ of a memory block of FIG. 3.

FIGS. 5 and 6 are diagrams three-dimensionally illustrating a section of a pillar formed in a memory block of FIG. 3.

FIG. 7 is an equivalent circuit diagram of a memory block of FIG. 3.

FIG. 8 is a diagram illustrating a plane structure of the equivalent circuit diagram of FIG. 7.

FIG. 9 is a diagram illustrating physical page buffers included in the SSD of FIG. 1.

FIGS. 10 and 11 are diagrams further illustrating operation of the SSD of FIG. 1.

FIG. 12 is a flow chart illustrating a method of programming data in a SSD of FIG. 1.

FIG. 13 is a cross-sectional view illustrating another example of a three-dimensional flash memory cell array of FIG. 2.

FIG. 14 is a block diagram illustrating a solid state drive (SSD) according to other example embodiments.

FIG. 15 is a block diagram illustrating an example of a non-volatile memory device included in the SSD of FIG. 14.

FIG. 16 is a circuit diagram illustrating an example of a memory block included in a two-dimensional flash memory cell array of FIG. 15.

FIGS. 17 to 20 are diagrams illustrating threshold voltage distributions of a multi-level cell of FIG. 16.

FIG. 21 is a diagram illustrating physical page buffers included in a SSD of FIG. 14.

FIGS. 22 and 23 are diagrams further illustrating operation of a level mix unit included in the SSD of FIG. 14.

FIGS. 24 and 25 are diagrams further illustrating operation of the SSD of FIG. 14 when physical pages included in a physical page group are coupled to a word line of the same order.

FIGS. 26 and 27 are diagrams further illustrating operation of the SSD of FIG. 14 when physical pages included in a physical page group are coupled to word lines of different orders.

FIG. 28 is a block diagram illustrating another example of a non-volatile memory device included in the SSD of FIG. 14.

FIGS. 29 and 30 are diagrams further illustrating operation of the SSD of FIG. 14 when the SSD includes the flash memory device of FIG. 28.

FIG. 31 is a flow chart summarizing a method of programming data in the SSD of FIG. 14.

FIG. 32 is a block diagram illustrating a storage device according to yet other example embodiments.

FIGS. 33 and 34 are diagrams further illustrating operation of the storage device of FIG. 32.

FIG. 35 is a block diagram illustrating a solid state drive (SSD) system according to still other example embodiments.

FIG. 36 is a block diagram illustrating an electronic device according still other example embodiments.

### DETAILED DESCRIPTION

Various example embodiments will be described more fully with reference to the accompanying drawings. The present inventive concept may, however, be embodied in many different forms and should not be construed as being limited to only the illustrated embodiments. Rather, these embodiments are provided so that this disclosure will be thorough and complete, and will fully convey the scope of the present inventive concept to those skilled in the art. Throughout the written description and drawings, like reference numbers and labels are used to denote like or similar elements and features.

It will be understood that, although the terms first (1st), second (2nd), etc. may be used herein to describe various elements, these elements should not be limited by these terms. These terms are used to distinguish one element from another. For example, a first element could be termed a second element, and, similarly, a second element could be termed a first element, without departing from the scope of the present inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the inventive concept. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As further background to the subject inventive concept, published U.S. patent application Ser. Nos. 13/236,249 and 13/236,176 are hereby incorporated by reference. A more complete understanding of bit error rate (BER) imbalance in a flash memory device may be had by review of these documents, for example.

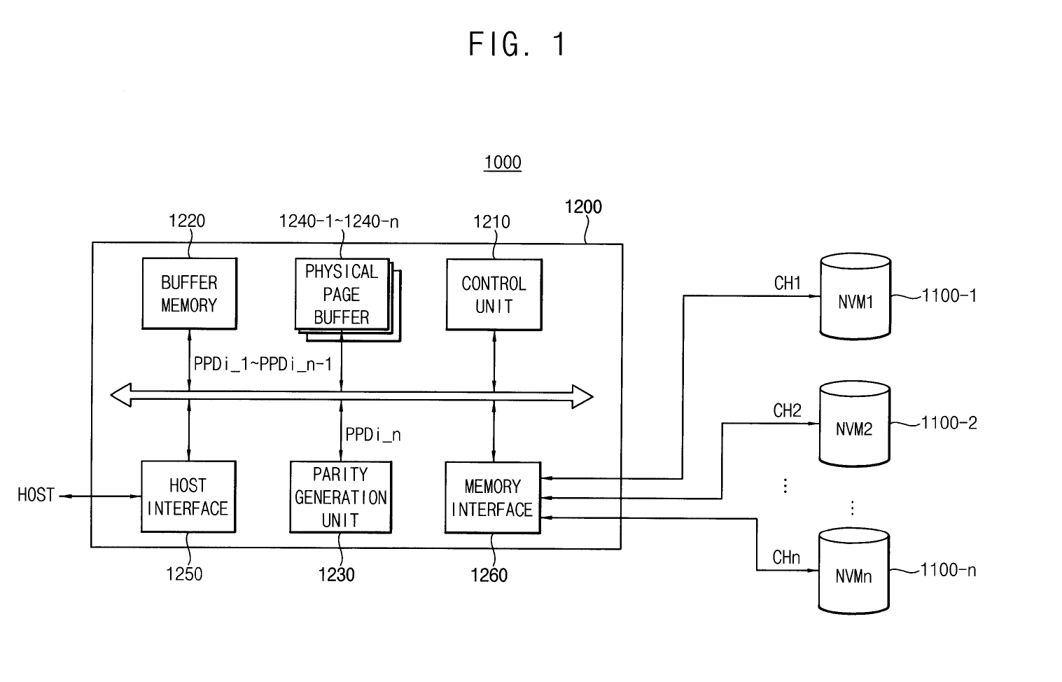

FIG. 1 is a block diagram illustrating a solid state drive (SSD) according to certain example embodiments.

Referring to FIG. 1, a SSD 1000 includes 1st through Nth non-volatile memory devices NVM1, NVM2, . . . , NVMn 1100-1, 1100-2, . . . , 1100-n and a redundant array of independent disks (RAID) controller 1200. Here, the variable indicators “N” and/or “n” are respective integers greater than one.

The SSD 1000 may be connected to a host, such as a laptop computer, a personal computer, a mobile device, a digital camera, etc., to be used as a storage device.

Each of the 1st through Nth non-volatile memory devices 1100-1, 1100-2, . . . , 1100-n includes a memory cell array including a plurality of physical pages.

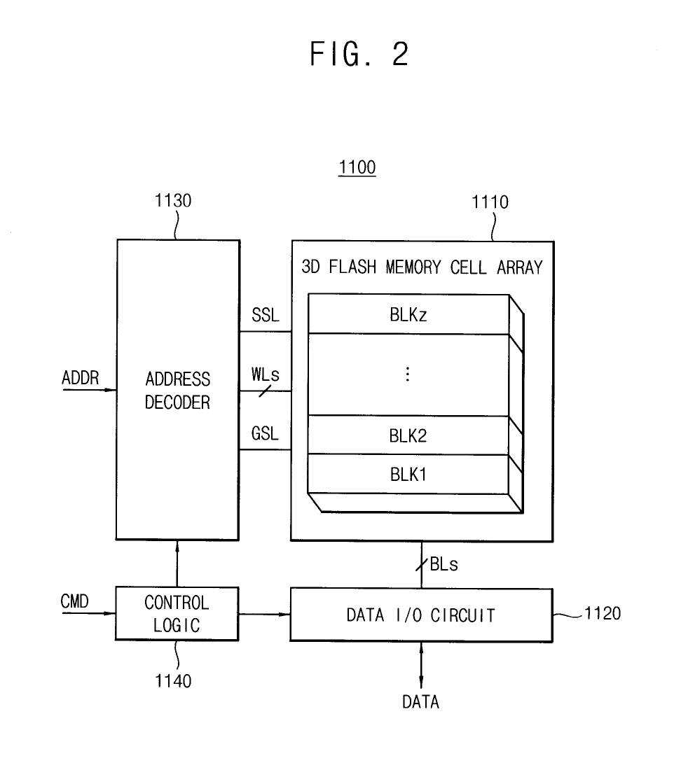

Due to variations in the manufacturing process(es) used to fabricate each one of the 1st through Nth non-volatile memory devices 1100-1, 1100-2, . . . , 1100-n, the plurality of physical pages included in each constituent memory cell array may have different bit error rates (BERs). Differences between bit error rates (BERs) of the plurality of physical pages will be described in some additional detail hereafter with reference to FIGS. 2 to 8.

Each one of the 1st through Nth non-volatile memory devices 1100-1, 1100-2, . . . , 1100-n is capable of performing program operations, read operations, and erase operations under control of the RAID controller 1200.

The RAID controller 1200 is respectively coupled to the 1st through Nth non-volatile memory devices 1100-1, 1100-2, . . . , 1100-n via 1st through Nth channels CH1, CH2, . . . , CHn.

The RAID controller 1200 may be used to buffer “input data” received from a host in units of a defined physical page in order to generate 1st through (N−1)th physical page data PPDi_1˜PPDi_(n−1). Here, the variable “i” is a positive integer. The RAID controller 1200 may also be used to perform a parity operation on the 1st through the (N−1)th physical page data PPDi_1˜PPDi_(n−1) to generate Nth physical page data PPDi_n, which is a parity data for the 1st through the (N−1)th physical page data PPDi_1˜PPDi_(n−1). In the illustrated example, the 1st through Nth physical page data PPDi_1˜PPDi_n constitute a “parity group”. In its operation the RAID controller 1200 serially generates parity groups.

The RAID controller 1200 may also be used to generate (or determine) a “physical page group” including 1st through Nth physical pages. The 1st through Nth physical pages are respectively selected from the 1st through Nth non-volatile memory devices 1100-1, 1100-2, . . . , 1100-n, such that at least two of the 1st through Nth physical pages have different bit error rates.

The RAID controller 1200 stores the 1st through Nth physical page data PPDi_1˜PPDi_n, included in a parity group in the 1st through Nth physical pages included in the physical page group, respectively. For example, the RAID controller 1200 may store the 1st physical page data PPDi_1 in the 1st physical page selected from the 1st non-volatile memory device 1100-1, store the 2nd physical page data PPDi_2 in the 2nd physical page selected from the 2nd non-volatile memory device 1100-2, and store the Nth physical page data PPDi_n in the Nth physical page selected from the Nth non-volatile memory device 1100-n.

FIG. 2 is a block diagram illustrating one example of a non-volatile memory device that may be included in the SSD of FIG. 1.

The 1st through Nth non-volatile memory devices 1100-1, 1100-2, . . . , 1100-n included in the SSD 1000 of FIG. 1 may be embodied as a flash memory device 1100 of FIG. 2.

Referring to FIG. 2, the flash memory device 1100 may include a three-dimensional (3D) flash memory cell array 1110, a data input/output (I/O) circuit 1120, an address decoder 1130 and a control logic 1140.

The 3D flash memory cell array 1110 may be formed on a substrate in a three-dimensional structure (or vertical structure). In a flash memory cell array having a two-dimensional structure (or horizontal structure), memory cells are formed in a planar arrangement parallel to a substrate. However, in the 3D flash memory cell array 1110, a plurality of planar arrangements of memory cells may be formed (or stacked) perpendicular to the substrate. The 3D flash memory cell array 1110 may include a plurality of physical pages coupled to a plurality of word lines WLs formed in order on the substrate such that respective “heights” defined by the plurality of word lines WLs in the memory cell array.

The 3D flash memory cell array 1110 may include a plurality of memory blocks BLK1, BLK2, . . . , BLKz, wherein the variable “z” is a positive integer. Each of the plurality of memory blocks BLK1, BLK2, . . . , BLKz may include a plurality of physical pages. Each of the plurality of physical pages may include a plurality of memory cells. The 3D flash memory cell array 1110 may perform a program operation and a read operation by a unit of a physical page and perform an erase operation by a unit of a memory block.

The data input/output (I/O) circuit 1120 may be connected to the 3D flash memory cell array 1110 through a plurality of bit lines BLs. The data I/O circuit 1120 may receive data (DATA) from the RAID controller 1200 and output data (DATA) read from the 3D flash memory cell array 1110 to the RAID controller 1200.

The address decoder 1130 may be connected to the 3D flash memory cell array 1110 through the plurality of word lines WLs, a string selection line SSL, and a ground selection line GSL. The address decoder 1130 may receive an address ADDR from the RAID controller 1200 and select a word line.

The control logic 1140 may control the program operation, the read operation, and the erase operation of the flash memory device 1100 by controlling the data I/O circuit 1120 and the address decoder 1130 based on a control signal CMD received from the RAID controller 1200. For example, during a program operation, the control logic 1140 may control the address decoder 1130 to allow a program voltage to be provided to a selected word line, and control the data I/O circuit 1120 to allow data to be programmed in memory cells connected to the selected word line.

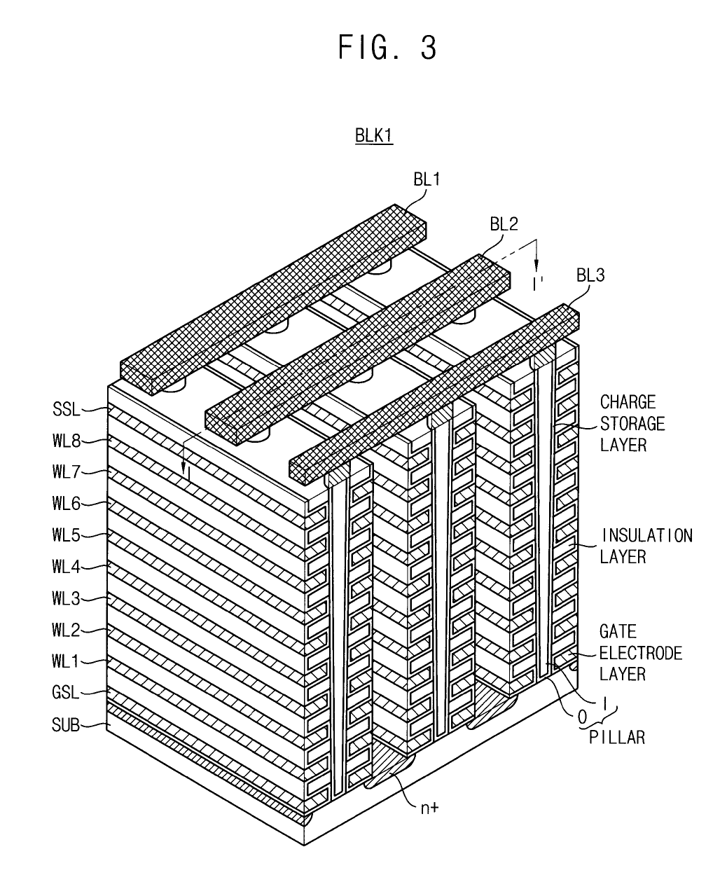

FIG. 3 is a perspective view further illustrating in one example a memory block having the 3D flash memory cell array of FIG. 2.

Each of the plurality of memory blocks BLK1, BLK2, . . . , BLKz included in the 3D flash memory cell array 1110 of FIG. 2 may be embodied as a memory block BLK1 of FIG. 3.

Referring to FIG. 3, the memory block BLK1 may be formed in a direction perpendicular to a substrate SUB. An n+ doped region may be formed in the substrate (SUB). A gate electrode layer and an insulation layer may be alternately deposited on the substrate. Also, a charge storage layer may be formed between the gate electrode layer and the insulation layer.

When the gate electrode layer and the insulation layer are vertically patterned, a V-shaped pillar may be formed. The pillar may penetrate the gate electrode layer and the insulation layer to be connected to the substrate. The outer portion “O” of the pillar may be configured with a channel semiconductor, and the inner portion “I” of the pillar may be configured with an insulation material such as silicon oxide.

Referring still to FIG. 3, the gate electrode layer of the memory block BLK1 may be connected to the ground selection line GSL, the plurality of word lines WL1 to WL8, and the string selection line SSL. The pillar of the memory block BLK1 may be connected to the plurality of bit lines BL1 to BL3. It is illustrated in FIG. 3, that one memory block BLK1 has two selection lines GSL and SSL, eight word lines WL1 to WL8, and three bit lines BL1 to BL3 as an example but embodiments of the inventive concept are not limited thereto.

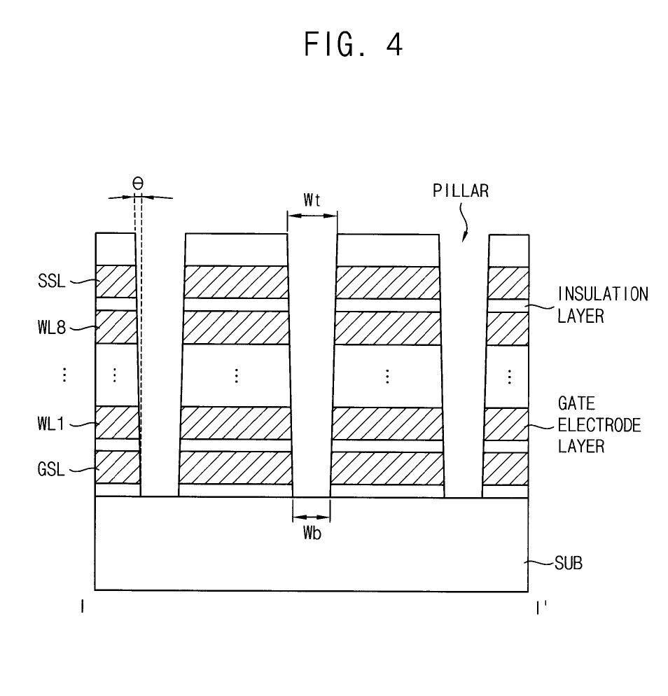

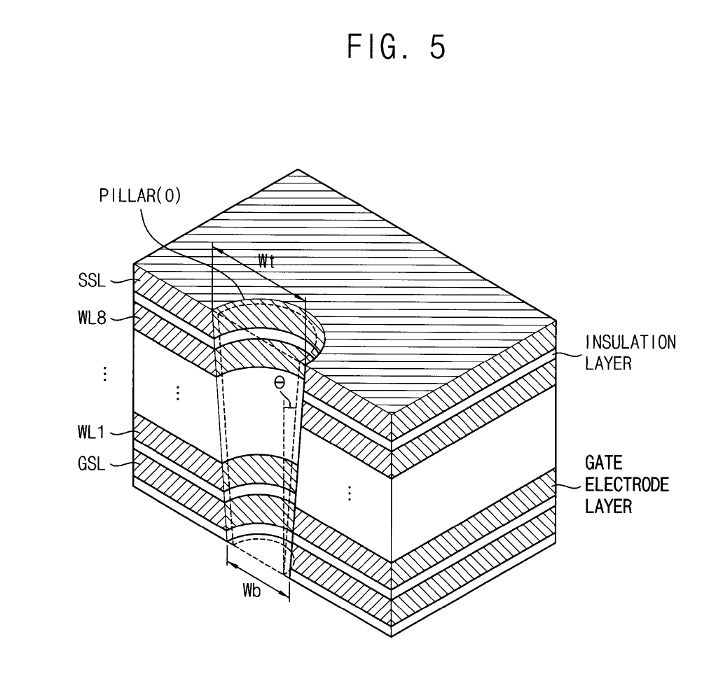

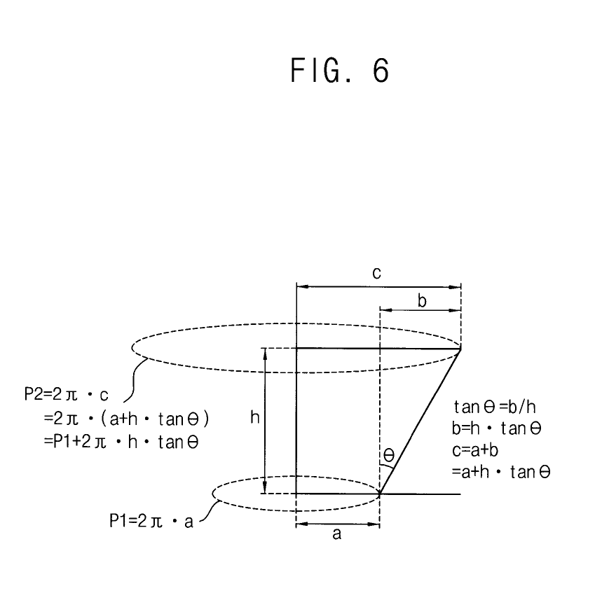

FIG. 4 is a cross-sectional view taken along line I-I′ of the memory block of FIG. 3, and FIGS. 5 and 6 are diagrams further illustrating one section of a pillar taken form the memory block of FIG. 3.

Referring collectively to FIGS. 4, 5 and 6, the insulation layer and the gate electrode layer are alternately stacked in a direction perpendicular to the substrate. The gate electrode layer may be connected to the gate selection line GSL, the string selection line SSL, and the word lines WL1 to WL8.

When vertical patterning is performed to form the pillar, the width of the pillar may be reduced as it approaches the bottom portion of the pillar (i.e., Wt>Wb). Accordingly, the pillar will have a V-shaped cylinder defined by an inclination angle θ. Due to the width difference between an upper portion of the pillar and a lower portion of the pillar, the circumference of the pillar will vary with the inclination angle θ and height above the substrate. As illustrated in FIG. 6, when the height between two planes crossing the pillar is “h”, and the radius of the pillar crossing the lower plane is “a”, the radius “c” of the pillar crossing the upper plane may be expressed by the equation: [c=a+b=a+h(tan θ)].

Further, the respective circumferences “P1” and “P2” of the pillar crossing the lower and upper planes may be expressed by the equations: [P1=2πa] and [P2=2πc=2π(a+b)=2πa+2πh(tan θ)=P1+2πh(tan θ)].

Hence, as shown above, the circumference of the pillar will vary with the height from the substrate. Accordingly, when the gate electrode layer is formed to have the same thickness, a facing area of the gate electrode layer may vary with the height. Here, the facing area may signify an area of the gate electrode layer facing the outer portion “O” of the pillar.

The gate electrode layer may be used as a gate electrode of a cell transistor, and the outer portion “O” of the pillar may be used as a channel region of the cell transistor. In this case, the circumference P1 or P2 of the pillar and the thickness “h” of the gate electrode layer may determine the aspect ratio (W/L) of the cell transistor. A drain current “Id” of a MOS transistor may be in proportion to the channel width “W” and may be in inverse proportion to the channel length “L”, as given by the equation: Id=α(W/L)(Vg−Vt)Vd, where “a” is a proportionality constant, “Vg” is a gate voltage, “Vd” is a drain voltage, and “Vt” is a threshold voltage.

Accordingly, cell transistors formed at different heights may have different current characteristics. That is, when the thickness of the gate electrode layer is equal, the current characteristics of the cell transistor may vary according to the height. For this reason, although an equal program or read voltage is applied to the word lines WL1 to WL8, the channel current may vary according to the height of the word line. This means that the threshold voltage of the cell transistor will vary with height, and height may be defined as a function of word line disposition. Further, if the threshold voltage of cell transistors changes as a function of location within the 3D memory cell array, the bit error rate (BER) of respective physical pages will also vary according to word line.

Referring again to FIG. 3, in the memory block BLK1, the width of the pillar may vary according to the height of the word line. For example, the width of the pillar may be reduced as it gets closer to the bottom portion of the pillar. This means that a “bit error rate (BER) imbalance” may arise as between different physical pages coupled to different word lines disposed at different heights above the substrate in a 3D memory cell array. For example, a physical page coupled to a relatively “low” (i.e., relatively near the substrate) word line may have a higher bit error rate (BER) than a physical page coupled to a relatively high (i.e., relatively distant from the substrate) word line.

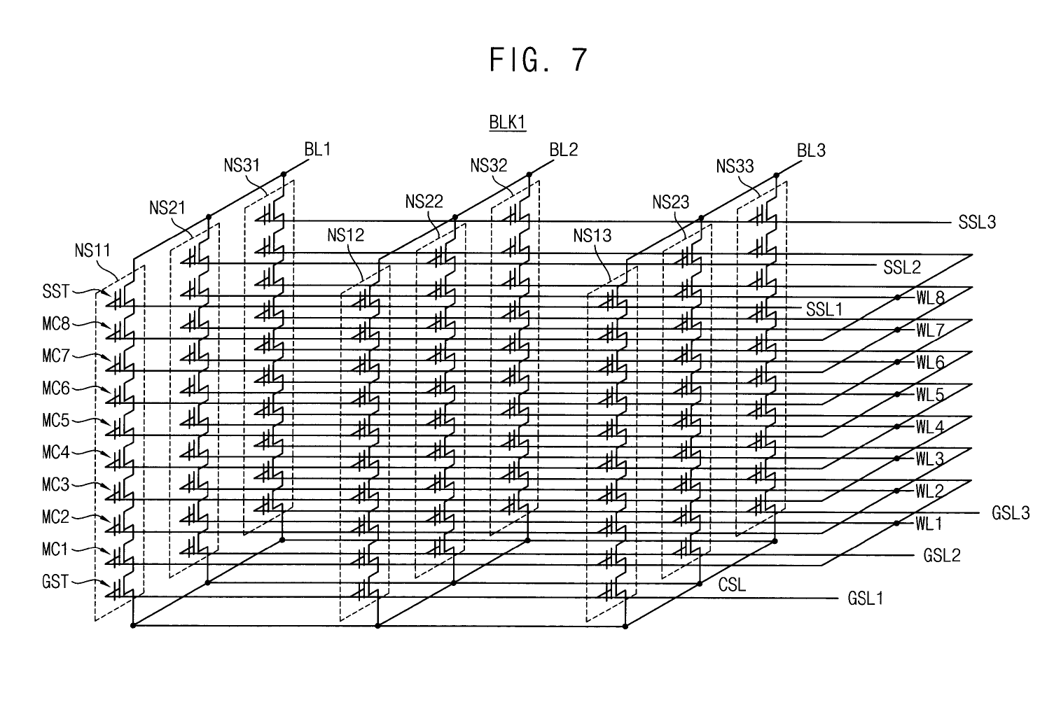

FIG. 7 is an equivalent circuit diagram of the memory block shown in FIG. 3.

Referring to FIG. 7, NAND strings NS11 to NS33 may be connected between the bit lines BL1 to BL3 and a common source line CSL. Each NAND string (e.g., NS11) may include a string selection transistor SST, a plurality of memory cells MC1 to MC8, and a ground selection transistor GST.

The string selection transistor SST may be connected to string selection lines SSL1 to SSL3. The plurality of memory cells MC1 to MC8 may be connected to corresponding word lines WL1 to WL8, respectively. The ground selection transistor GST may be connected to ground selection lines GSL1 to GSL3. The string selection transistor SST may be connected to the bit lines BL1 to BL3, and the ground selection transistor GST may be connected to the common source line CSL.

Referring again to FIG. 7, word lines (e.g., WL1) having the same height may be commonly connected and the ground selection lines GSL1 to GSL3 and the string selection lines SSL1 to SSL3 may be separated. For example, when a physical page that includes memory cells connected to the 1st word line WL1 and included in the NAND strings NS11, NS12, and NS13 is programmed, the 1st word line WL1, the 1st string selection lines SSL1, and the 1st ground selection line GSL1 may be selected.

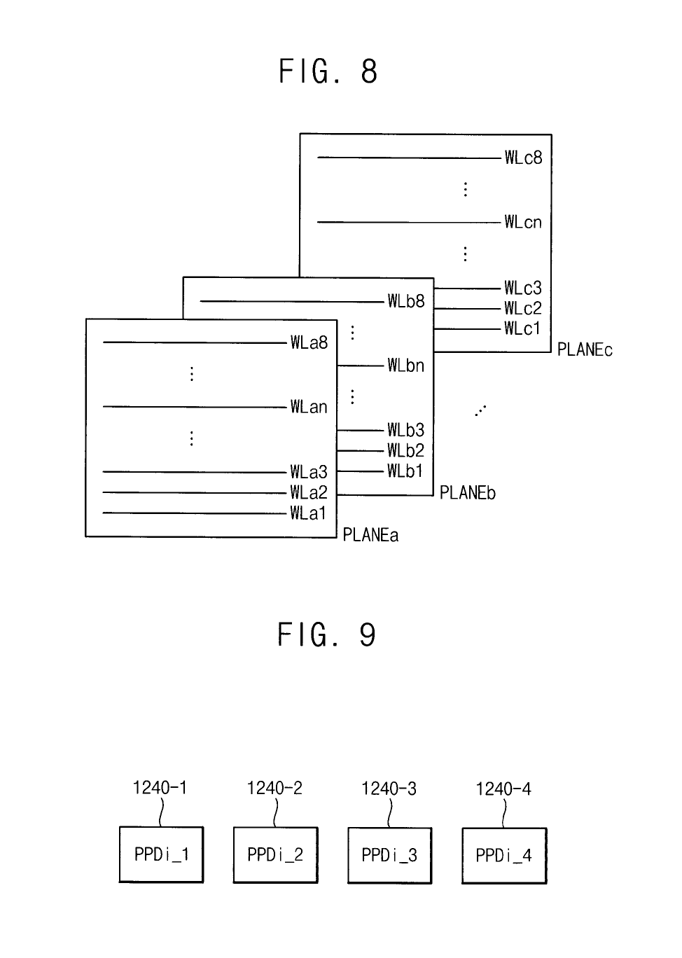

FIG. 8 is a diagram illustrating a planar structure of the equivalent circuit diagram shown in FIG. 7.

Referring to FIG. 8, the memory block BLK1 of FIG. 7 may include three planes. In FIG. 7, the NAND strings NS11, NS12 and NS13 may constitute a 1st plane PLANEa, the NAND strings NS21, NS22 and NS23 may constitute a 2nd plane PLANEb, and the NAND strings NS31, NS32 and NS33 may constitute a 3rd plane PLANEc. The 1st word line WL1 may be divided into WLa1, WLb1, and WLc1, and the 2nd word line WL2 may be divided into WLa2, WLb2, and WLc2 according to planes. Similarly, the 8th word line WL8 may be divided into WLa8, WLb8, and WLc8 according to planes.

Memory cells included in the same plane and coupled to a word line of the same height may constitute a physical page.

The program order among the planes may vary. For example, the program operation may be sequentially performed from the 1st plane PLANEa to the 3rd plane PLANEc. In each plane, the program operation may be sequentially performed from a physical page coupled to the 1st word line WL1 to a physical page coupled to the 8th word line WL8. Alternatively, the program operation may be sequentially performed from a physical page coupled to the 8th word line WL8 to a physical page coupled to the 1st word line WL1. As illustrated in FIG. 8, more than three planes may be included in the memory block BLK1.

Referring again to FIG. 1, the RAID controller 1200 may include a control unit 1210, a buffer memory 1220, a parity generation unit 1230, 1st through Nth physical page buffers 1240-1, 1240-2, . . . , 1240-n, a host interface 1250, and a memory interface 1260.

The host interface 1250 may exchange data with the host. The host interface 1250 may provide an interface with the SSD 1000 according to a protocol of the host. The host interface 1250 may communicate with the host via (e.g.,) a universal serial bus (USB), a small computer system interface (SCSI), a PCI express, ATA, a parallel ATA (PATA), a serial ATA (SATA), or a serial attached SCSI (SAS). Moreover, the host interface 1250 may perform disk emulation whereby the host may recognize the SSD 1000 as a legacy hard disk drive (HDD).

The memory interface 1260 may be used to respectively exchange data with the 1st through Nth non-volatile memory devices 1100-1, 1100-2, . . . , 1100-n via the 1st through Nth channels CH1, CH2, . . . , CHn.

The buffer memory 1220 may be used to temporarily store data to be programmed or data to be provided to the host. For example, the buffer memory 1220 may buffer data, received from the host on a physical page basis (i.e., according to the defined physical page as a data transfer unit) to thereby generate the 1st through the (N−1)th physical page data PPDi_1˜PPDi_(n−1). The buffer memory 1220 may repeatedly be used to buffer data corresponding to (N−1) physical pages and outputting the buffered data as the 1st through the (N−1)th physical page data PPDi_1˜PPDi_(n−1), where “i” represents each of the 1st through the (N−1)th physical page data PPDi_1˜PPDi_(n−1) as output from the buffer memory 1220.

The parity generation unit 1230 may be used to generate the Nth physical page data PPDi_n by performing the parity operation on the 1st through the (N−1)th physical page data PPDi_1˜PPDi_(n−1). Using this approach, the Nth physical page data PPDi_n will be parity data for the 1st through the (N−1)th physical page data PPDi_1˜PPDi_(n−1). The 1st through Nth physical page data PPDi_1˜PPDi_n may constitute a “parity group”. In certain embodiments, a parity operation may be accomplished using one or more logic operations such as the exclusive OR (XOR) operation. Assuming the use of an XOR operation, the parity generation unit 1230 may generate the Nth physical page data PPDi_n by performing an exclusive OR (XOR) operation on the 1st through the (N−1)th physical page data PPDi_1˜PPDi_(n−1).

The 1st through Nth physical page buffers 1240-1, 1240-2, . . . , 1240-n may store the 1st through Nth physical page data PPDi_1˜PPDi_n, which are included in the same parity group, respectively. For example, as illustrated in FIG. 9, the 1st physical page buffer 1240-1 may store the 1st physical page data PPDi_1, the 2nd physical page buffer 1240-2 may store the 2nd physical page data PPDi_2, and the Nth physical page buffer 1240-n may store the Nth physical page data PPDi_n. In FIG. 9, the variable “N” is assumed to be four in the working example, however embodiments of the inventive concept are not limited thereto.

The control unit 1210 may be used to determine the physical page group including the 1st through Nth physical pages. The 1st through Nth physical pages are selected from the 1st through Nth non-volatile memory devices 1100-1, 1100-2, . . . , 1100-n, respectively, such that at least two of the 1st through Nth physical pages have different bit error rates (BERs).

As described above with reference to FIGS. 2 to 8, when each of the 1st through Nth non-volatile memory devices 1100-1, 1100-2, . . . , 1100-n includes the 3D flash memory cell array 1110, physical pages coupled to word lines at different heights above the substrate may have different bit error rates (BERs). Therefore, at least two (2) of the 1st through Nth physical pages included in the physical page group will be coupled to word lines at different heights in the 3D memory cell array.

In certain example embodiments, the control unit 1210 may be used to select a 1st word line having a 1st height in the 3D memory cell array and a 2nd word line having a 2nd height in the 3D memory cell array different from the 1st height from among the plurality of word lines. Further, the control unit 1210 may be used to select one of a physical page coupled to the 1st word line and a physical page coupled to the 2nd word line from each of the 1st through Nth non-volatile memory devices 1100-1, 1100-2, . . . , 1100-n to define the physical page group. In this case, at least one of the 1st through Nth physical pages included in the physical page group will be coupled to the 1st word line having the 1st height and remainder of the 1st through Nth physical pages included in the physical page group may be coupled to the 2nd word line having the 2nd height.

The control unit 1210 may be used to control the memory interface 1260 to store the 1st through Nth physical page data PPDi_1˜PPDi_n, which are stored in the 1st through Nth physical page buffers 1240-1, 1240-2, . . . , 1240-n, respectively, in the 1st through Nth physical pages, respectively, included in the physical page group.

As described above, the RAID controller 1200 may be used to receive “write data” (i.e., input data to be written to the 1st through Nth non-volatile memory devices 1100-1, 1100-2, . . . , 1100-n) from the host, generate a parity data “associated with” (i.e., derived from the write data using one or more conventional parity data generating techniques) the write data, and then store the write data together with the parity data in a dispersed manner “across” the 1st through Nth non-volatile memory devices 1100-1, 1100-2, . . . , 1100-n.

Therefore, although certain errors occur on some of the 1st through Nth non-volatile memory devices 1100-1, 1100-2, . . . , 1100-n such that some of the data stored in the 1st through Nth physical page data PPDi_1˜PPDi_n is damaged, the RAID controller 1200 may nonetheless recover the damaged data by performing the parity operation on undamaged data included in the parity group.

However, in circumstances where more than a given threshold number of data among the 1st through Nth physical page data PPDi_1˜PPDi_n included in a parity group are damaged, the RAID controller 1200 may not be able to recover the damaged data using the parity operation. Herein, the term “threshold number” will be understood by those skilled in the art as being determined according to the particular parity operation being used.

The data recovery rate of a SSD may be determined by the number of times the SSD 1000 is not able to recover damaged data. Therefore, if the 1st through Nth physical page data PPDi_1˜PPDi_n included in a parity group are stored in physical pages all of which have a high bit error rate (BER), the data recovery rate of a SSD may decrease.

As described above, the physical pages included in the 1st through Nth non-volatile memory devices 1100-1, 1100-2, . . . , 1100-n may have different bit error rates (BERs) according to the word lines WLs to which the physical pages are coupled. Therefore, if the 1st through Nth physical page data PPDi_1˜PPDi_n included in the same parity group are stored in physical pages coupled to a word line having a given height, the data recovery rate imbalance may exist between parity groups, such that the number of times the SSD 1000 is not able to recover damaged data is increased.

However, SSD according to certain example embodiments of the inventive concept may operate in such a manner that a physical page group including the 1st through Nth physical pages is defined, such that at least two (2) of the 1st through Nth physical pages included in the physical page group are respectively coupled to two (2) word lines having different heights in the 3D memory cell array. Further, SSD according to certain example embodiments of the inventive concept may store the 1st through Nth physical page data PPDi_1˜PPDi_n included in the parity group in the 1st through Nth physical pages included in the physical page group, respectively. Therefore, the data recovery rate imbalance between parity groups may be reduced, and the number of times SSD according to certain example embodiments of the inventive concept may not be able to recover damaged data may also be reduced. As such, SSD according to certain example embodiments of the inventive concept will increase overall stability.

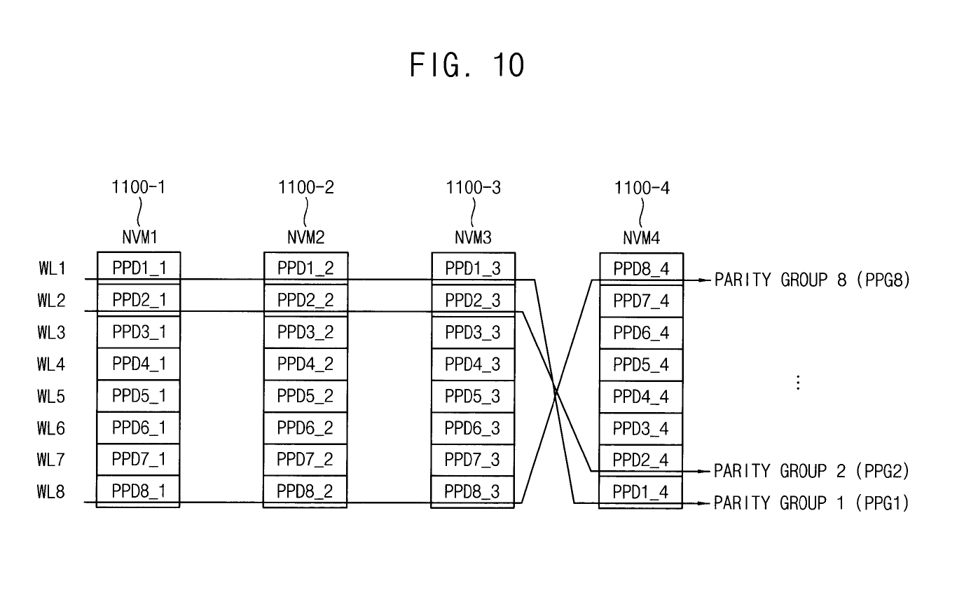

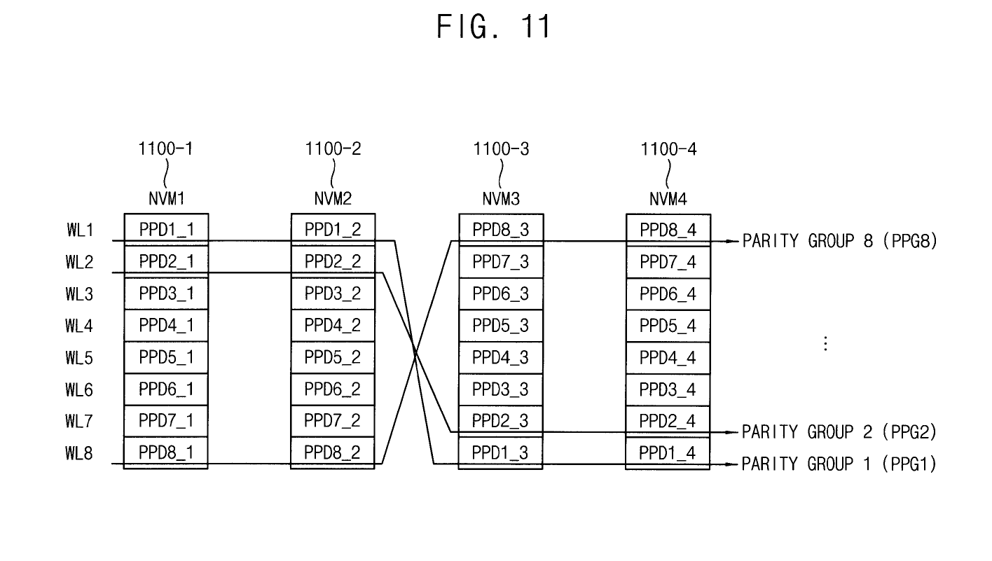

FIGS. 10 and 11 are diagrams further illustrating operation of the SSD of FIG. 1.

It is assumed in FIGS. 10 and 11, that the SSD 1000 includes only 1st through 4th non-volatile memory devices 1100-1, 1100-2, 1100-3 and 1100-4 (i.e., “N”=4) and that the 3D flash memory cell array 1110 includes 1st through 4th non-volatile memory devices 1100-1, 1100-2, 1100-3 and 1100-4 respectively coupled to 1st through 8th word lines WL1 to WL8. Those skilled in the art will, however, understand that this is merely a selected example and that the scope of the inventive concept is not limited thereto.

Hereinafter, operation of the SSD 1000 will be described with reference to FIGS. 1 to 11.

The buffer memory 1220 may buffer data, which are received from the host, by a unit of a physical page and generate the 1st through the (N−1)th physical page data PPDi_1˜PPDi_(n−1). The parity generation unit 1230 may generate the Nth physical page data PPDi_n by performing the parity operation on the 1st through the (N−1)th physical page data PPDi_1˜PPDi_(n−1). The 1st through Nth physical page data PPDi_1˜PPDi_n may constitute a parity group. The 1st through Nth physical page buffers 1240-1, 1240-2, . . . , 1240-n may store the 1st through Nth physical page data PPDi_1˜PPDi_n, which are included in the parity group, respectively.

The control unit 1210 may determine the physical page group including the 1st through Nth physical pages. The 1st through Nth physical pages may be selected from the 1st through Nth non-volatile memory devices 1100-1, 1100-2, . . . , 1100-n, respectively, such that at least two of the 1st through Nth physical pages have different bit error rates (BERs). For example, the control unit 1210 may determine a plurality of the physical page groups by selecting one physical page in an order from a physical page coupled to a lowest word line in the 3D memory cell array to a physical page coupled to a highest word line in the 3D memory cell array from at least one of the 1st through Nth non-volatile memory devices 1100-1, 1100-2, . . . , 1100-n and selecting one physical page in an order from a physical page coupled to the highest word line in the 3D memory cell array to a physical page coupled to the lowest word line in the 3D memory cell array from a remainder of the 1st through Nth non-volatile memory devices 1100-1, 1100-2, . . . , 1100-n.

As illustrated in FIG. 10, the control unit 1210 may be used to determine a plurality of the physical page groups PPG1 to PPG8 by selecting one physical page in an order from a physical page coupled to a lowest word line WL1 in the 3D memory cell array to a physical page coupled to a highest word line WL8 in the 3D memory cell array from the 1st, the 2nd and the 3rd non-volatile memory devices 1100-1, 1100-2 and 1100-3 and selecting one physical page in an order from a physical page coupled to the highest word line WL8 in the 3D memory cell array to a physical page coupled to the lowest word line WL1 in the 3D memory cell array from the 4th non-volatile memory device 1100-4.

In this case, the control unit 1210 may determine a 1st physical page group PPG1 by selecting a physical page coupled to a 1st word line WL1 from the 1st, the 2nd and the 3rd non-volatile memory devices 1100-1, 1100-2 and 1100-3 and selecting a physical page coupled to an 8th word line WL8 from the 4th non-volatile memory device 1100-4, and then store the 1st through 4th physical page data PPD1_{—}1˜PPD1_{—}4, which are included in a 1st parity group (PARITY GROUP 1) and stored in the 1st through 4th physical page buffers 1240-1, 1240-2, 1240-3 and 1240-4, respectively, in the 1st through 4th physical pages, respectively, included in the 1st physical page group PPG1.

Then, the control unit 1210 may determine a 2nd physical page group PPG2 by selecting a physical page coupled to a 2nd word line WL2 from the 1st, the 2nd and the 3rd non-volatile memory devices 1100-1, 1100-2 and 1100-3 and selecting a physical page coupled to a 7th word line WL7 from the 4th non-volatile memory device 1100-4, and then store the 1st through 4th physical page data PPD2_{—}1˜PPD2_{—}4, which are included in a 2nd parity group (PARITY GROUP 2) and stored in the 1st through 4th physical page buffers 1240-1, 1240-2, 1240-3 and 1240-4, respectively, in the 1st through 4th physical pages, respectively, included in the 2nd physical page group PPG2.

In a similar way, the control unit 1210 may determine an 8th physical page group PPG8 by selecting a physical page coupled to the 8th word line WL8 from the 1st, the 2nd and the 3rd non-volatile memory devices 1100-1, 1100-2 and 1100-3 and selecting a physical page coupled to the 1st word line WL1 from the 4th non-volatile memory device 1100-4, and then store the 1st through 4th physical page data PPD8_{—}1˜PPD8_{—}4, which are included in an 8th parity group (PARITY GROUP 8) and stored in the 1st through 4th physical page buffers 1240-1, 1240-2, 1240-3 and 1240-4, respectively, in the 1st through 4th physical pages, respectively, included in the 8th physical page group PPG8.

In other example embodiments, as illustrated in FIG. 11, the control unit 1210 may determine a plurality of the physical page groups PPG1 to PPG8 by selecting one physical page in an order from a physical page coupled to a lowest word line WL1 in the 3D memory cell array to a physical page coupled to a highest word line WL8 in the 3D memory cell array from the 1st and the 2nd non-volatile memory devices 1100-1 and 1100-2 and selecting one physical page in an order from a physical page coupled to the highest word line WL8 in the 3D memory cell array to a physical page coupled to the lowest word line WL1 in the 3D memory cell array from the 3rd and the 4th non-volatile memory devices 1100-3 and 1100-4.

In this case, the control unit 1210 may determine the 1st physical page group PPG1 by selecting a physical page coupled to the 1st word line WL1 from the 1st and the 2nd non-volatile memory devices 1100-1 and 1100-2 and selecting a physical page coupled to the 8th word line WL8 from the 3rd and the 4th non-volatile memory devices 1100-3 and 1100-4, and then store the 1st through 4th physical page data PPD1_{—}1˜PPD1_{—}4, which are included in the 1st parity group (PARITY GROUP 1) and stored in the 1st through 4th physical page buffers 1240-1, 1240-2, 1240-3 and 1240-4, respectively, in the 1st through 4th physical pages, respectively, included in the 1st physical page group PPG1. After that, the control unit 1210 may determine the 2nd physical page group PPG2 by selecting a physical page coupled to the 2nd word line WL2 from the 1st and the 2nd non-volatile memory devices 1100-1 and 1100-2 and selecting a physical page coupled to the 7th word line WL7 from the 3rd and the 4th non-volatile memory devices 1100-3 and 1100-4, and then store the 1st through 4th physical page data PPD2_{—}1˜PPD2_{—}4, which are included in the 2nd parity group (PARITY GROUP 2) and stored in the 1st through 4th physical page buffers 1240-1, 1240-2, 1240-3 and 1240-4, respectively, in the 1st through 4th physical pages, respectively, included in the 2nd physical page group PPG2.

In similar manner, the control unit 1210 may determine the 8th physical page group PPG8 by selecting a physical page coupled to the 8th word line WL8 from the 1st and the 2nd non-volatile memory devices 1100-1 and 1100-2 and selecting a physical page coupled to the 1st word line WL1 from the 3rd and the 4th non-volatile memory devices 1100-3 and 1100-4, and then store the 1st through 4th physical page data PPD8_{—}1˜PPD8_{—}4, which are included in the 8th parity group (PARITY GROUP 8) and stored in the 1st through 4th physical page buffers 1240-1, 1240-2, 1240-3 and 1240-4, respectively, in the 1st through 4th physical pages, respectively, included in the 8th physical page group PPG8.

As described above, SSD according to the embodiments of the inventive concept may determine a physical page group including the 1st through Nth physical pages, such that at least two of the 1st through Nth physical pages included in the physical page group are coupled to word lines having different heights in the 3D memory cell array, and then store the 1st through Nth physical page data PPDi_1˜PPDi_n included in a given parity group in the 1st through Nth physical pages included in the physical page group, respectively. As a result, the data recovery rate imbalance between parity groups is decreased, and the number of times the SSD 1000 may not be able to recover damaged data is also decreased. In other words, SSD according to the embodiments of the inventive concept will operate with increased overall stability over analogous conventional SSD.

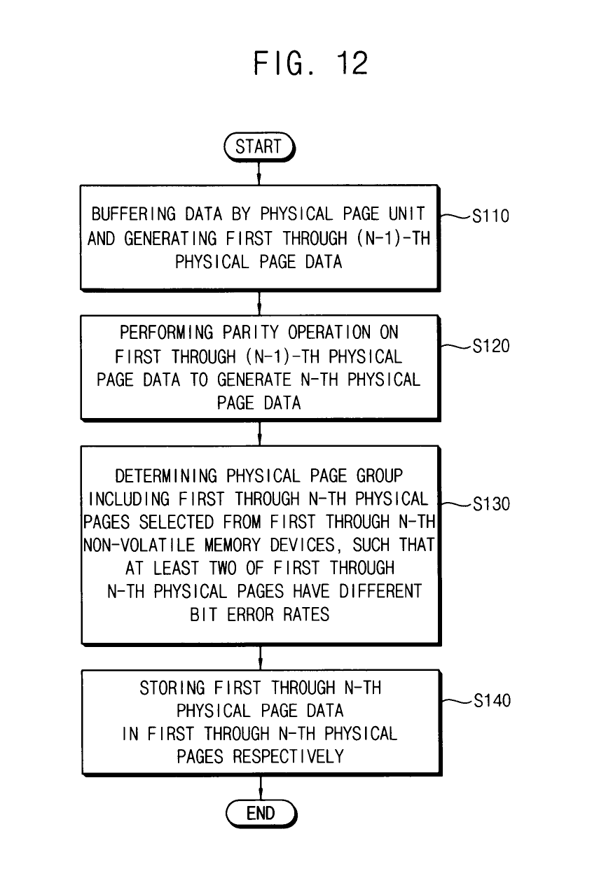

FIG. 12 is a flow chart summarizing one possible method of programming data in the SSD of FIG. 1.

Referring to FIG. 12, the SSD 1000 buffers data, which are received from the host, by a unit of a physical page and generates the 1st through the (N−1)th physical page data PPDi_1˜PPDi_(n−1) (S110). The SSD 1000 performs the parity operation on the 1st through the (N−1)th physical page data PPDi_1˜PPDi_(n−1) to generate the Nth physical page data PPDi_n, which is a parity data for the 1st through the (N−1)th physical page data PPDi_1˜PPDi_(n−1) (S120). The 1st through Nth physical page data PPDi_1˜PPDi_n may constitute a parity group. The SSD 1000 determines a physical page group including 1st through Nth physical pages that are selected from the 1st through Nth non-volatile memory devices 1100-1, 1100-2, . . . , 1100-n, respectively, such that at least two of the 1st through Nth physical pages have different bit error rates from each other (S130). The SSD 1000 stores the 1st through Nth physical page data PPDi_1˜PPDi_n, which are included in the same parity group, in the 1st through Nth physical pages, which are included in the physical page group, respectively (S140).

The method of programming data in a SSD described above with reference to FIG. 12 may be performed by the SSD 1000 of FIG. 1, as the structure and operation of the SSD 1000 of FIG. 1 have been described above with reference to FIGS. 1 to 11. Therefore, a detailed description of steps in FIG. 12 will be omitted here.

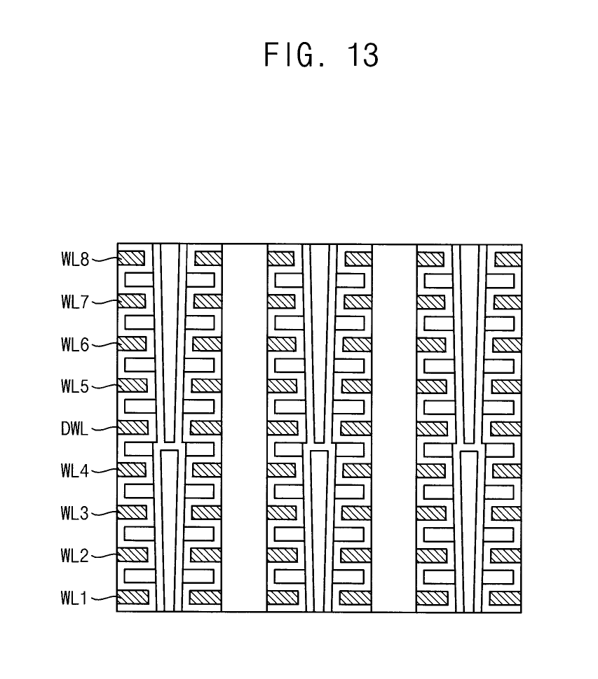

FIG. 13 is a cross-sectional view illustrating another example of a three-dimensional (3D) flash memory cell array of FIG. 2.

As illustrated in FIG. 13, the SSD 1000 and the programming method thereof according to example embodiments of the inventive concept may be applied to the case where two or more pillars are formed on a substrate. Referring to FIG. 13, a dummy word line DWL may exist between 4th and 5th word lines WL4 and WL5.

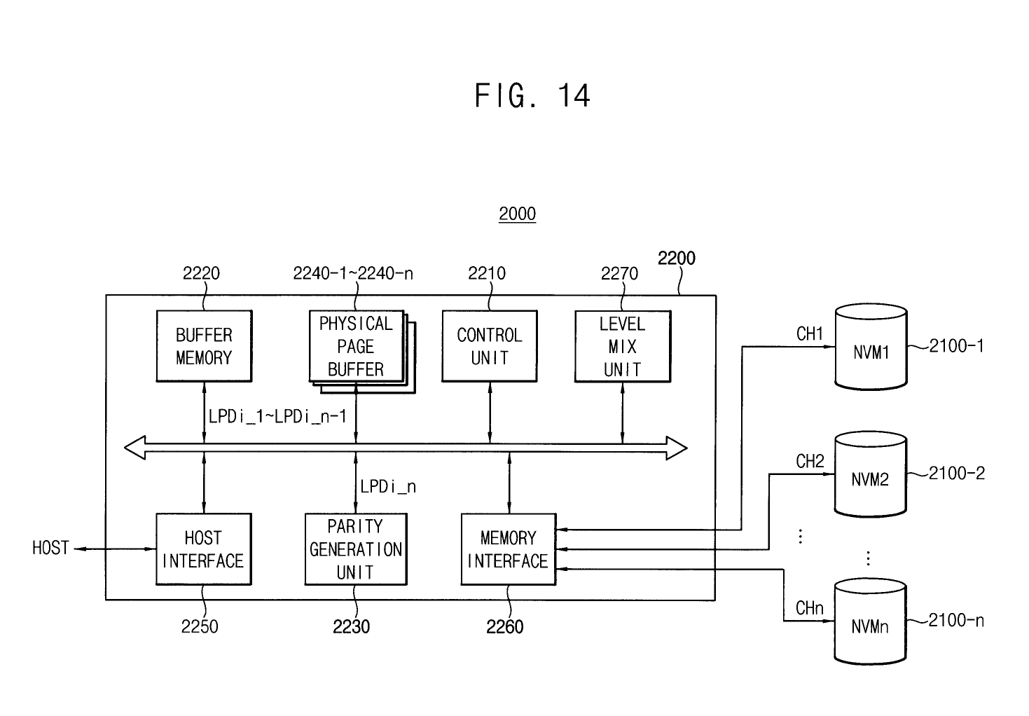

FIG. 14 is a block diagram illustrating a solid state drive (SSD) according to other example embodiments.

Referring to FIG. 14, a SSD 2000 includes 1st through Nth non-volatile memory devices NVM1, NVM2, . . . , NVMn 2100-1, 2100-2, . . . , 2100-n and a redundant array of independent disks (RAID) controller 2200.

The SSD 2000 may be connected to a host, such as a laptop computer, a personal computer, a mobile device, a digital camera, etc., to be used as a storage device.

Each of the 1st through Nth non-volatile memory devices 2100-1, 2100-2, . . . , 2100-n includes a memory cell array that have a plurality of physical pages.

Single bit data or multi bit data, i.e., data of two or more bits, may be stored in one memory cell. A memory cell storing single bit data is called as a single-level cell (SLC) and a memory cell storing multi bit data is called as a multi-level cell (MLC) or a multi bit cell.

The memory cell array included in each of the 1st through Nth non-volatile memory devices 2100-1, 2100-2, . . . , 2100-n includes multi-level cells storing M-bit data, where “M” is an integer greater one. Therefore, each of the plurality of physical pages included in the memory cell array includes M logical pages. Hereinafter, the M logical pages included in a physical page will be called as 1st level through Mth level logical pages. The 1st level logical page represents a group of data that are stored in a least significant bit (LSB) of the multi-level cells included in one physical page. Similarly, the Mth level logical page represents a group of data that are stored in a most significant bit (MSB) of the multi-level cells included in one physical page.

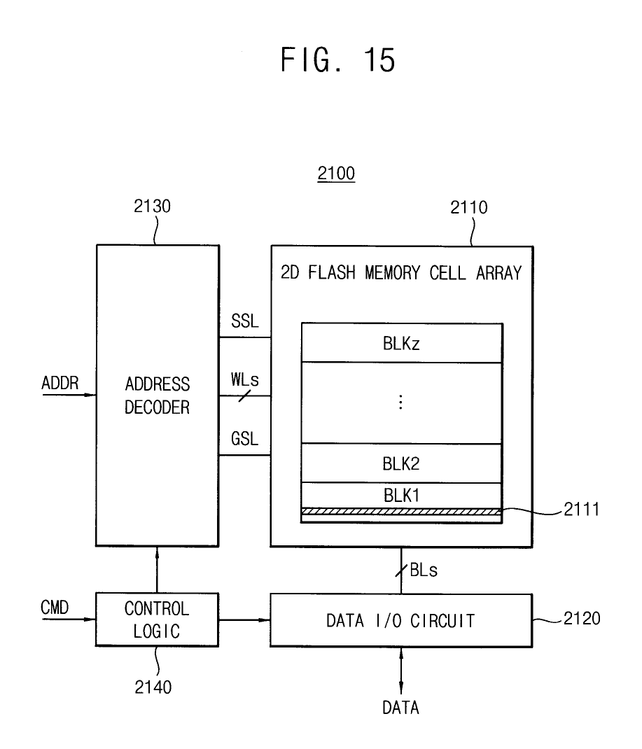

According to a manufacturing process, the 1st level through the Mth level logical pages included in a physical page may have different bit error rates (BERs) from each other. The differences between bit error rates (BERs) of the 1st level through the Mth level logical pages will be described later with reference to FIGS. 15 to 20.

As before, the 1st through Nth non-volatile memory devices 2100-1, 2100-2, . . . , 2100-n are able to perform program operations, read operations, and erase operations under control of the RAID controller 2200.

The RAID controller 2200 is respectively coupled to the 1st through Nth non-volatile memory devices 2100-1, 2100-2, . . . , 2100-n via 1st through Nth channels CH1, CH2, . . . , CHn.

The RAID controller 2200 buffers data, which are received from a host, by a unit of a logical page and generates 1st through (N−1)th logical page data LPDi_1˜LPDi_(n−1). The RAID controller 2200 performs a parity operation on the 1st through the (N−1)th logical page data LPDi_1˜LPDi_(n−1) to generate Nth logical page data LPDi_n, which is a parity data for the 1st through the (N−1)th logical page data LPDi_1˜LPDi_(n−1). The 1st through Nth logical page data LPDi_1˜LPDi_n may constitute a parity group. The RAID controller 2200 repeatedly generates a plurality of the parity groups, and i represents a serial number of the parity groups.

The RAID controller 2200 determines a physical page group including 1st through Nth physical pages. The 1st through Nth physical pages are selected from the 1st through Nth non-volatile memory devices 2100-1, 2100-2, . . . , 2100-n, respectively.

The RAID controller 2200 determines a logical page group including 1st through Nth logical pages. The 1st through Nth logical pages are selected from the 1st through Nth physical pages, respectively, such that at least two of the 1st through Nth logical pages are of different levels. In some example embodiments, each of the 1st through Nth logical pages included in the same logical page group may be one of two different levels.

The RAID controller 2200 stores the 1st through Nth logical page data LPDi_1˜LPDi_n, which are included in the parity group, in the 1st through Nth logical pages, respectively, included in the logical page group. For example, the RAID controller 2200 may store the 1st logical page data LPDi_1 in the 1st logical page selected from the 1st physical page included in the 1st non-volatile memory device 2100-1, store the 2nd logical page data LPDi_2 in the 2nd logical page selected from the 2nd physical page included in the 2nd non-volatile memory device 2100-2, and store the Nth logical page data LPDi_n in the Nth logical page selected from the Nth physical page included in the Nth non-volatile memory device 2100-n.

FIG. 15 is a block diagram further illustrating an example of a non-volatile memory device included in the SSD of FIG. 14.

The 1st through Nth non-volatile memory devices 2100-1, 2100-2, . . . , 2100-n included in the SSD 2000 of FIG. 14 may be embodied as a flash memory device 2100 of FIG. 15.

Referring to FIG. 15, the flash memory device 2100 may include a two-dimensional flash memory cell array 2110, a data input/output (I/O) circuit 2120, an address decoder 2130 and a control logic 2140.

The two-dimensional (2D) flash memory cell array 2110 may be formed on a substrate in a two-dimensional (or horizontal) structure. In a flash memory cell array having a 2D or horizontal structure, memory cells may be formed in a direction parallel to a substrate. The 2D flash memory cell array 2110 may include a plurality of physical pages coupled to a plurality of word lines WLs formed in order on the substrate such that heights of the plurality of word lines are the same.

The 2D flash memory cell array 2110 may include a plurality of memory blocks BLK1, BLK2, . . . , BLKz. Here, z is a positive integer. Each of the plurality of memory blocks BLK1, BLK2, . . . , BLKz may include a plurality of physical pages 2111. Each of the plurality of physical pages 2111 may include a plurality of multi-level cells. Each of the plurality of multi-level cells may store M-bit data. The 2D flash memory cell array 2110 may perform a program operation and a read operation by a unit of a physical page and perform an erase operation by a unit of a memory block.

The data I/O circuit 2120 may be connected to the 2D flash memory cell array 2110 through a plurality of bit lines BLs. The data I/O circuit 2120 may receive data (DATA) from the RAID controller 2200 and output data (DATA) read from the 2D flash memory cell array 2110 to the RAID controller 2200.

The address decoder 2130 may be connected to the 2D flash memory cell array 2110 through the plurality of word lines WLs, a string selection line SSL, and a ground selection line GSL. The address decoder 2130 may receive an address ADDR from the RAID controller 2200 and select a word line.

The control logic 2140 may control the program operation, the read operation, and the erase operation of the flash memory device 2100 by controlling the data I/O circuit 2120 and the address decoder 2130 based on a control signal CMD received from the RAID controller 2200. For example, in the program operation, the control logic 2140 may control the address decoder 2130 to allow a program voltage to be provided to a selected word line, and control the data I/O circuit 2120 to allow data to be programmed in memory cells connected to the selected word line.

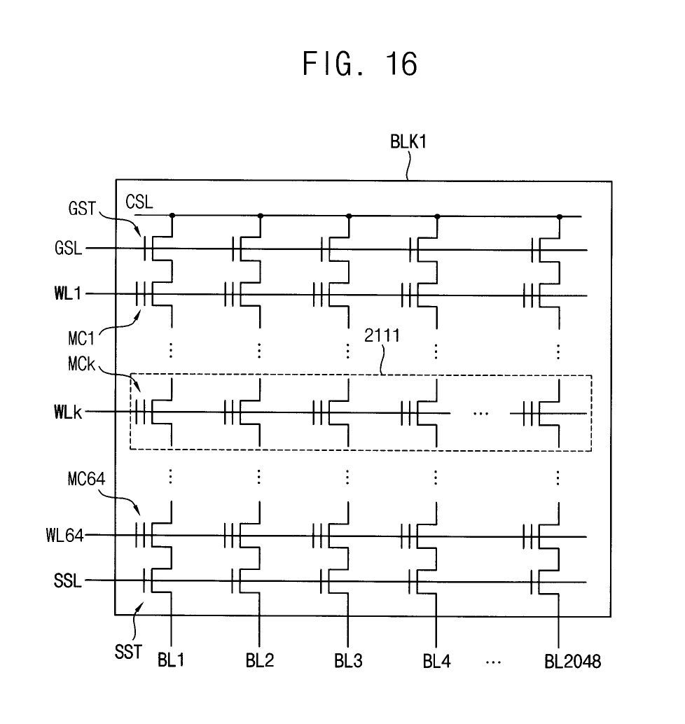

FIG. 16 is a circuit diagram illustrating in one example the memory block included in the 2D flash memory cell array of FIG. 15.

Each of the plurality of memory blocks BLK1, BLK2, . . . , BLKz included in the 2D flash memory cell array 2110 of FIG. 15 may be embodied as a memory block BLK1 of FIG. 16.

Referring to FIG. 16, the memory block BLK1 may have a cell string structure. One cell string may include a string selection transistor SST, a plurality of multi-level cells MC1 to MC64, and a ground selection transistor GST. It is illustrated in FIG. 16, that one cell string includes two selection lines GSL and SSL, sixty-four word lines WL1 to WL64, and 2048 bit lines BL1 to BL2048 as an example, but embodiments are not limited thereto.

The string selection transistor SST may be connected to the string selection line SSL, the plurality of multi-level cells MC1 to MC64 may be connected to the plurality of word lines WL1 to WL64, and the ground selection transistor GST may be connected to the ground selection line GSL. The string selection transistor SST may be connected to bit lines BL1 to BL2048 and the ground selection transistor GST may be connected to a common source line CSL.

A plurality of multi-level cells may be connected to one word line (e.g., WLk, wherein “k” is a positive integer less than or equal to 64 in the particular example). A set of the multi-level cells connected to one word line is defined as a “physical page”.

The multi-level cells MC1 to MC64 included in the 2D flash memory cell array 2110 may store M-bit data.

The single-level cell (SLC) may have an erase state and a program state according to a threshold voltage. On the other hand, the multi-level cell (MLC) may have an erase state and a plurality of program states according to threshold voltages.

Since the 2D flash memory cell array 2110 includes multi-level cells storing M-bit data, each of the plurality of physical pages included in the 2D flash memory cell array 2110 may include M logical pages, that is, the 1st level through the Mth level logical pages. For example, when the 2D flash memory cell array 2110 includes multi-level cells storing two bits, one physical page included in the 2D flash memory cell array 2110 may have two logical pages. When the 2D flash memory cell array 2110 includes multi-level cells storing three bits, one physical page included in the 2D flash memory cell array 2110 may have three logical pages. When the 2D flash memory cell array 2110 includes multi-level cells storing four bits, one physical page included in the 2D flash memory cell array 2110 may have four logical pages. Here, the 1st level logical page represents a group of data that are stored in a least significant bit (LSB) of the multi-level cells included in one physical page. Similarly, the Mth level logical page represents a group of data that are stored in a most significant bit (MSB) of the multi-level cells included in one physical page.

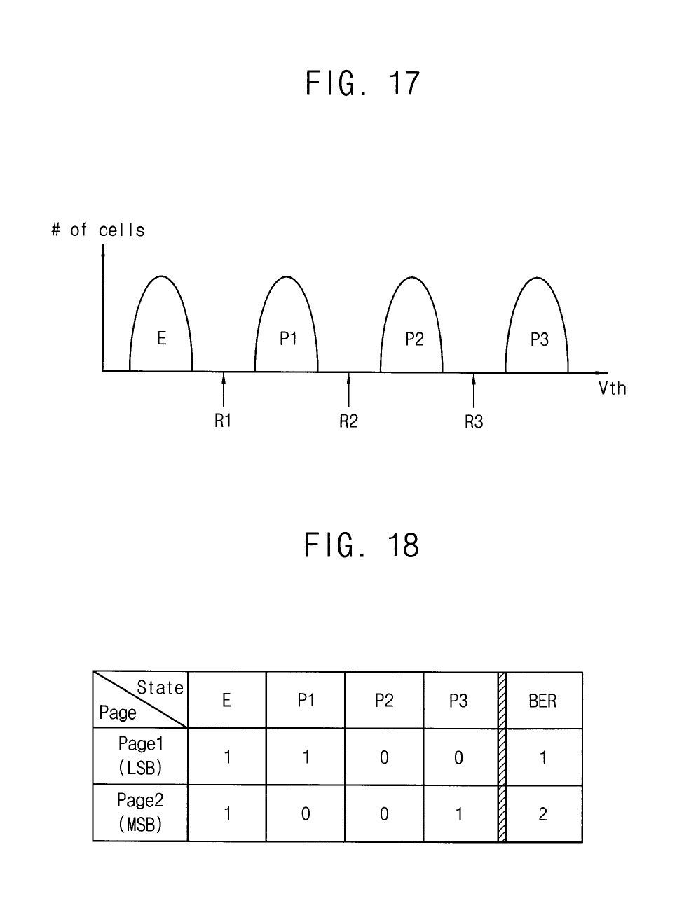

FIGS. 17, 18, 19 and 20 are respective diagrams further illustrating threshold voltage distributions of the MLC of FIG. 16.

FIGS. 17 and 18 exemplarily illustrate a threshold voltage distribution of multi-level cells when 2-bit data are stored in one memory cell. In FIG. 17, the horizontal axis represents a threshold voltage (Vth) of the multi-level cell and the vertical axis represents the number of multi-level cells (# of cells). As illustrated in FIG. 17, the multi-level cell may have one of four states E, P1, P2, and P3 according to a threshold voltage distribution. Here, “E” represents an erase state and “P1”, “P2”, and “P3” represent program states. In FIG. 17, “R1”, “R2” and “R3” represent read voltage levels for reading (i.e., discriminating between) the respective program states P1, P2, P3 and the erase state E.

When 2-bit data is to be stored, the MLC will have four states. In this case, referring to FIG. 18, one physical page (e.g., 2111 of FIG. 16) may include a 1st level logical page PAGE1 (or LSB) and a 2nd level logical page PAGE2 (or MSB). A multi-level cell having the erase state E may store ‘11’, a multi-level cell having the 1st program state P1 may store ‘10’, a multi-level cell having the 2nd program state P2 may store ‘00’, and a multi-level cell having the 3rd program state P3 may store ‘01’.

Data read from the 2D flash memory cell array 2110 may exhibit different bit error rate (BER) according to the “levels” of the logical pages in a physical page. As the level of a logical page increases, a bit error rate (BER) may increase by a factor of two (2). For example, if a number of fail bits is identical in each reading level, the bit error rate (BER) of the 1st level logical page PAGE1 (or LSB) may be 1 and the bit error rate (BER) of the 2nd level logical page PAGE2 (or MSB) may be 2.

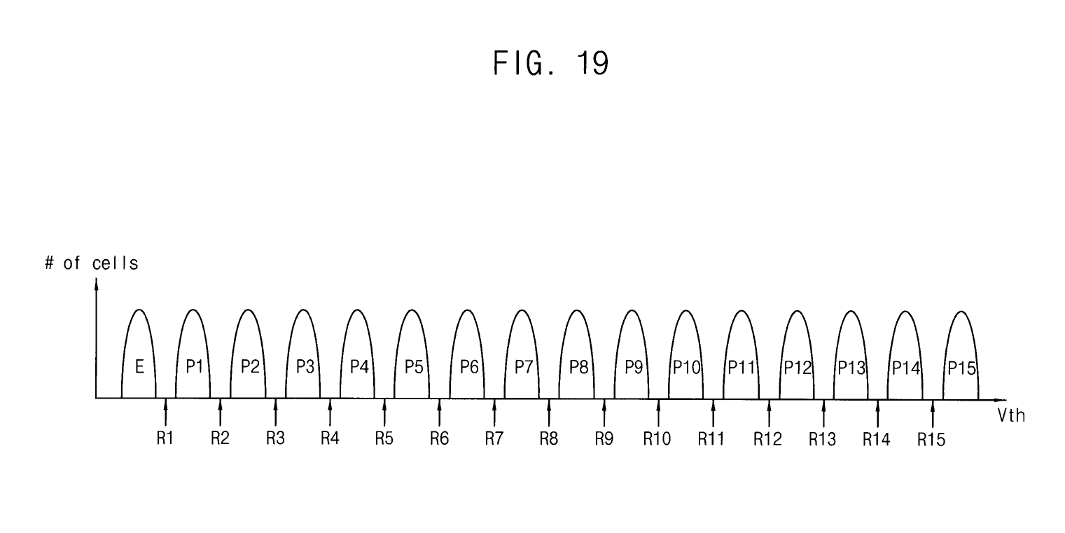

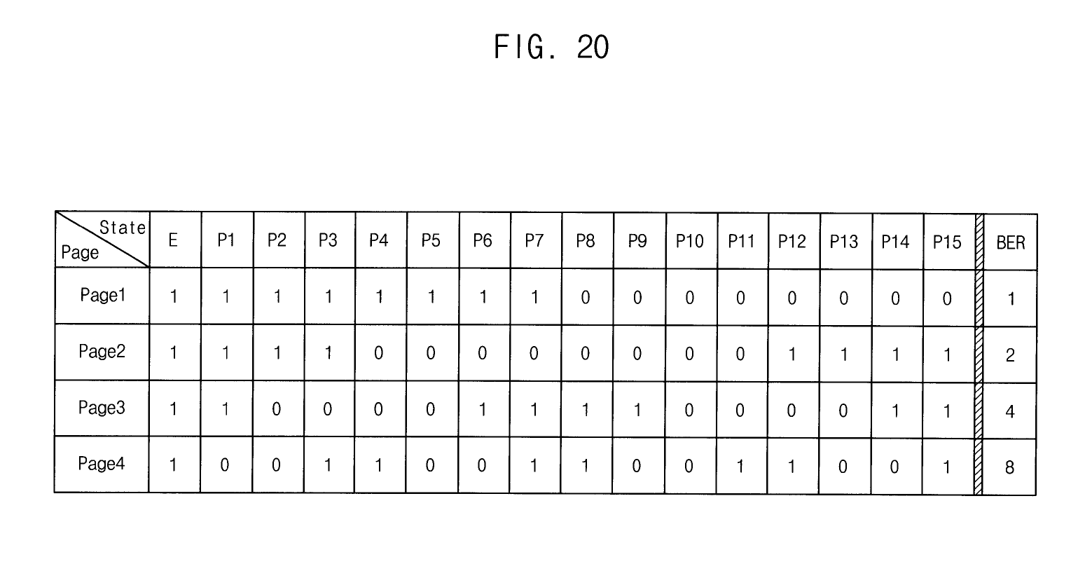

FIGS. 19 and 20 further illustrate a threshold voltage distribution of MLC when 4-bit data are stored per memory cell. In FIG. 19, the horizontal axis represents a threshold voltage Vth of the multi-level cell and the vertical axis represents the number of multi-level cells (# of cells). As illustrated in FIG. 19, the multi-level cell may have one of sixteen states E, P1, P2, . . . , P15 according to a threshold voltage distribution. Here, “E” again represents an erase state and “P1”, “P2”, . . . , “P15” represent program states. In FIG. 19, “R1”, “R2”, . . . , “R15” represent respective read voltage levels.

When 4-bit data is to be stored, the MLC will have sixteen (16) states. In this case, referring to FIG. 20, one physical page (e.g., 2111 of FIG. 16) may include a 1st level logical page PAGE1, a 2nd level logical page PAGE2, a 3rd level logical page PAGE3, and a 4th level logical page PAGE4. A multi-level cell having the erase state E may store ‘1111’, a multi-level cell having the 1st program state P1 may store ‘1110’, a multi-level cell having the 2nd program state P2 may store ‘1100’, and a multi-level cell having the fifteenth program state P15 may store ‘0111’.

Data read from the 2D flash memory cell array 2110 may exhibit different bit error rate (BER) according to the level of constituent logical pages. As a level of a logical page increases, its bit error rate (BER) may increase by a factor of two. For example, if the number of fail bits is identical in each reading level, the bit error rate (BER) of the 1st level logical page PAGE1 may be 1, the bit error rate (BER) of the 2nd level logical page PAGE2 may be 2, the bit error rate (BER) of the 3rd level logical page PAGE3 may be 4, and the bit error rate (BER) of the 4th level logical page PAGE4 may be 8. If M-bit data is stored in one MLC, the bit error rate (BER) for each of N logical pages may be 1:2:2̂2: . . . :2̂(M−1).

Referring again to FIG. 14, the RAID controller 2200 may include a control unit 2210, a buffer memory 2220, a parity generation unit 2230, 1st through Nth physical page buffers 2240-1, 2240-2, . . . , 2240-n, a host interface 2250, a memory interface 2260, and a level mix unit 2270.

The host interface 2250 may be used to exchange data with the host. The host interface 2250 may provide an interface with the SSD 2000 according to one or more protocol(s) recognized by the host. For example, the host interface 2250 may communicate with the host via a universal serial bus (USB), a small computer system interface (SCSI), a PCI express, ATA, a parallel ATA (PATA), a serial ATA (SATA), and a serial attached SCSI (SAS). Moreover, the host interface 2250 may perform disk emulation whereby the host is able to recognize the SSD 2000 as a legacy hard disk drive (HDD).

The memory interface 2260 may be used to respectively exchange data with the 1st through Nth non-volatile memory devices 2100-1, 2100-2, . . . , 2100-n via the 1st through Nth channels CH1, CH2, . . . , CHn.

The buffer memory 2220 may be used to temporarily store data to be programmed or data to be provided to the host. For example, the buffer memory 2220 may buffer data, which are received from the host, by a unit of a logical page and generate the 1st through the (N−1)th logical page data LPDi_1˜LPDi_(n−1). The buffer memory 2220 may repeatedly perform buffering data corresponding to (N−1) logical pages and outputting the buffered data as the 1st through the (N−1)th logical page data LPDi_1˜LPDi_(n−1). Here, the variable “i” represents a serial number of the 1st through the (N−1)th logical page data LPDi_1˜LPDi_(n−1) output by the buffer memory 2220.

The parity generation unit 2230 may be used to generate the Nth logical page data LPDi_n by performing the parity operation on the 1st through the (N−1)th logical page data LPDi_1˜LPDi_(n−1). The Nth logical page data LPDi_n may be a parity data for the 1st through the (N−1)th logical page data LPDi_1˜LPDi_(n−1). The 1st through Nth logical page data LPDi_1˜LPDi_n may constitute a parity group. In some example embodiments, the parity operation may be an exclusive OR (XOR) operation. In this case, the parity generation unit 2230 may generate the Nth logical page data LPDi_n by performing an exclusive OR (XOR) operation on the 1st through the (N−1)th logical page data LPDi_1˜LPDi_(n−1).

The 1st through Nth physical page buffers 2240-1, 2240-2, . . . , 2240-n may store the 1st through Nth logical page data LPDi_1˜LPDi_n, which are included in the same parity group, respectively, M times in consecutive order. That is, the 1st through Nth physical page buffers 2240-1, 2240-2, . . . , 2240-n may receive the 1st through Nth logical page data LPDi_1˜LPDi_n, respectively, M times and store the 1st through Nth logical page data LPDi_1˜LPDi_n, respectively, M times in the received order.

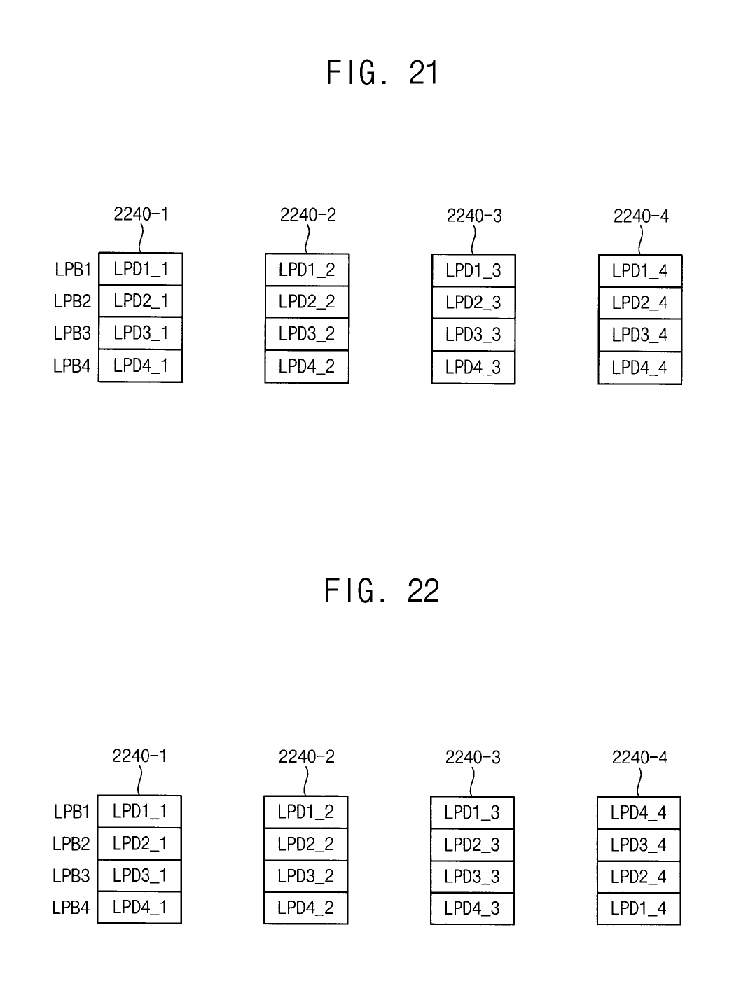

Each of the 1st through Nth physical page buffers 2240-1, 2240-2, . . . , 2240-n may include 1st through Mth logical page buffers. In this case, as illustrated in FIG. 21, the 1st through 4th physical page buffers 2240-1, 2240-2, 2240-3 and 2240-4 may receive 1st through 4th logical page data LPD1_{—}1, LPD1_{—}2, LPD1_{—}3 and LPD1_{—}4, which are included in a 1st parity group, respectively, and store the 1st through 4th logical page data LPD1_{—}1, LPD1_{—}2, LPD1_{—}3 and LPD1_{—}4, respectively, in a 1st logical page buffer LPB1. And then, the 1st through 4th physical page buffers 2240-1, 2240-2, 2240-3 and 2240-4 may receive 1st through 4th logical page data LPD2_{—}1, LPD2_{—}2, LPD2_{—}3 and LPD2_{—}4, which are included in a 2nd parity group, respectively, and store the 1st through 4th logical page data LPD2_{—}1, LPD2_{—}2, LPD2_{—}3 and LPD2_{—}4, respectively, in a 2nd logical page buffer LPB2. And then, the 1st through 4th physical page buffers 2240-1, 2240-2, 2240-3 and 2240-4 may receive 1st through 4th logical page data LPD3_{—}1, LPD3_{—}2, LPD3_{—}3 and LPD3_{—}4, which are included in a 3rd parity group, respectively, and store the 1st through 4th logical page data LPD3_{—}1, LPD3_{—}2, LPD3_{—}3 and LPD3_{—}4, respectively, in a 3rd logical page buffer LPB3. And then, the 1st through 4th physical page buffers 2240-1, 2240-2, 2240-3 and 2240-4 may receive 1st through 4th logical page data LPD4_{—}1, LPD4_{—}2, LPD4_{—}3 and LPD4_{—}4, which are included in a 4th parity group, respectively, and store the 1st through 4th logical page data LPD4_{—}1, LPD4_{—}2, LPD4_{—}3 and LPD4_{—}4, respectively, in a 4th logical page buffer LPB4. In FIG. 21, the variable “N” and “M” are assumed to be four (4) as an example, but the scope of the inventive concept is not limited thereto.

The level mix unit 2270 may select at least one of the 1st through Nth physical page buffers 2240-1, 2240-2, . . . , 2240-n and change an order of the M logical page data stored in each of the selected physical page buffers. In some example embodiments, the level mix unit 2270 may reverse the order of the M logical page data stored in each of the selected physical page buffers.

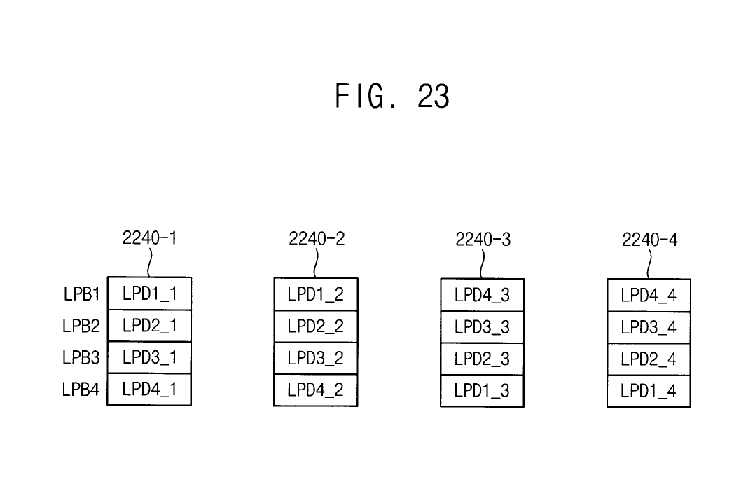

FIGS. 22 and 23 are diagrams further illustrating operation of a level mix unit included in the SSD of FIG. 14.

In some example embodiments, as illustrated in FIG. 22, the level mix unit 2270 may reverse the order of the M logical page data stored in one of the 1st through Nth physical page buffers 2240-1, 2240-2, . . . , 2240-n. That is, comparing a diagram of FIG. 22 with a diagram of FIG. 21, the level mix unit 2270 may reverse the order of the M logical page data stored in the 4th physical page buffer 2240-4.

In other example embodiments, as illustrated in FIG. 23, the level mix unit 2270 may reverse the order of the M logical page data stored in two of the 1st through Nth physical page buffers 2240-1, 2240-2, . . . , 2240-n. That is, comparing a diagram of FIG. 23 with a diagram of FIG. 21, the level mix unit 2270 may reverse the order of the M logical page data stored in the 3rd physical page buffer 2240-3 and the 4th physical page buffer 2240-4.

The control unit 2210 may determine the physical page group including the 1st through Nth physical pages. The 1st through Nth physical pages may be selected from the 1st through Nth non-volatile memory devices 2100-1, 2100-2, . . . , 2100-n, respectively. The control unit 2210 may control the memory interface 2260 to store the M logical page data, which are stored in the 1st through Mth logical pages LPB1, LPB2, LPB3 and LPB4 of each of the 1st through Nth physical page buffers 2240-1, 2240-2, . . . , 2240-n, in the 1st level through the Mth level logical pages included in each of the 1st through Nth physical pages, respectively. For example, the control unit 2210 may store the M logical page data, which are stored in the 1st through Mth logical pages LPB1, LPB2, LPB3 and LPB4 of the Jth physical page buffers 2240-j, in the 1st level through the Mth level logical pages included in the Jth physical page that is selected from the Jth non-volatile memory device 2100-j, respectively. Here, “J” is a positive integer less than or equal to “N”.

As described above, the RAID controller 2200 receives write data from the host, generates parity data from the write data, and stores the write data together with the parity data in a dispersed manner across the 1st through Nth non-volatile memory devices 2100-1, 2100-2, . . . , 2100-n. Therefore, although certain errors occur on some of the 1st through Nth non-volatile memory devices 2100-1, 2100-2, . . . , 2100-n such that some of the 1st through Nth logical page data LPDi_1˜LPDi_n included in a parity group are damaged, the RAID controller 2200 may recover the damaged data by performing the parity operation on undamaged data included in the parity group.

However, when more than a threshold number of data among the 1st through Nth logical page data LPDi_1˜LPDi_n included in a parity group are damaged, the RAID controller 2200 may not be able to recover the damaged data using the parity operation. As before, the threshold number of data will be determined by the particular the parity operation being used.

Data recovery rate of a SSD may be determined by the number of times the SSD 2000 is not able to recover damaged data. Therefore, if the 1st through Nth logical page data LPDi_1˜LPDi_n included in a parity group are stored in logical pages all of which have a high bit error rate (BER), the data recovery rate of a SSD may decrease.

As described above, the logical pages included in a physical page of the 1st through Nth non-volatile memory devices 2100-1, 2100-2, . . . , 2100-n may have different bit error rates (BERs) according to levels of logical pages in a physical page. Therefore, if the 1st through Nth logical page data LPDi_1˜LPDi_n included in the same parity group are stored in logical pages of the same level, the data recovery rate imbalance may exist between parity groups, such that the number of times the SSD 2000 is not able to recover damaged data may increase.

However, according to the SSD 2000, the level mix unit 2270 may select at least one of the 1st through Nth physical page buffers 2240-1, 2240-2, . . . , 2240-n and reverse an order of the M logical page data stored in each of the selected physical page buffers before the control unit 2210 stores the M logical page data, which are stored in the 1st through Mth logical pages LPB1, LPB2, LPB3 and LPB4 of each of the 1st through Nth physical page buffers 2240-1, 2240-2, . . . , 2240-n, in the 1st level through the Mth level logical pages included in each of the 1st through Nth physical pages, respectively. Therefore, the 1st through Nth logical page data LPDi_1˜LPDi_n included in the same parity group may be stored in a dispersed manner across the logical pages having a relatively high bit error rate (BER) and the logical pages having a relatively low bit error rate (BER). As a result, the data recovery rate imbalance between parity groups is decreased, and the number of times the SSD 2000 may not be able to recover damaged data is also decreased. As such, the SSD 2000 provides increased overall stability.

As described above, the 2D flash memory cell array 2110 included in each of the 1st through Nth non-volatile memory devices 2100-1, 2100-2, . . . , 2100-n may include a plurality of physical pages coupled to a plurality of word lines WLs formed in order on the substrate such that the height of the plurality of word lines is the same.

In some example embodiments, the control unit 2210 may determine the physical page group including the 1st through Nth physical pages that are selected from the 1st through Nth non-volatile memory devices 2100-1, 2100-2, . . . , 2100-n, respectively, such that the 1st through Nth physical pages are coupled to a word line of the same order.

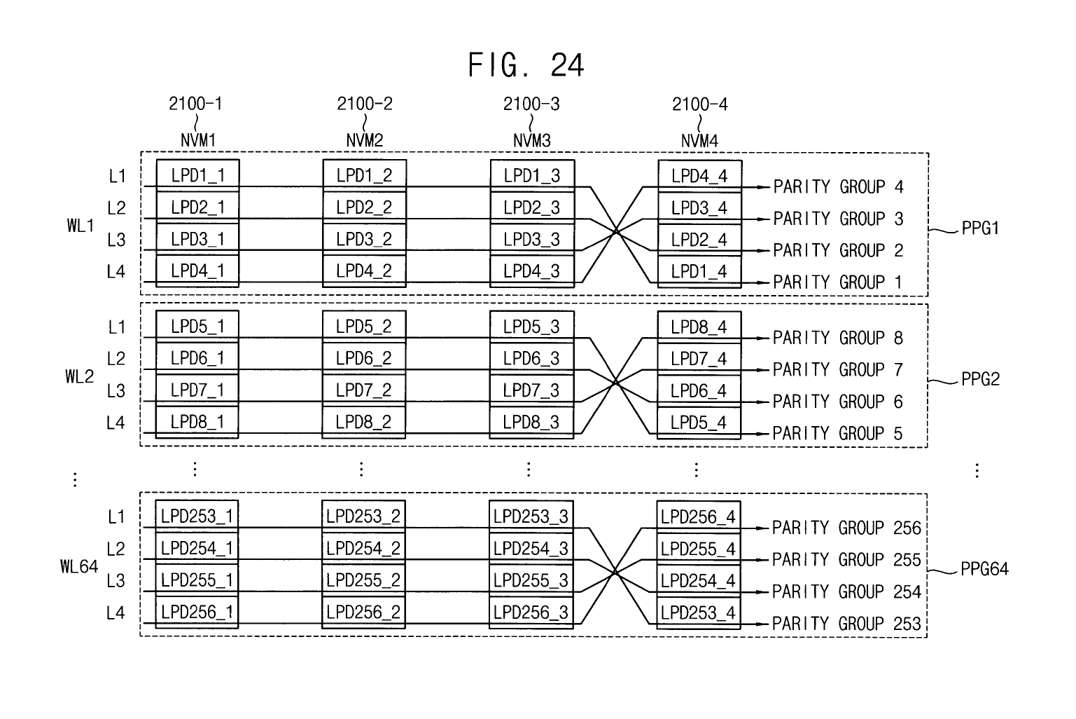

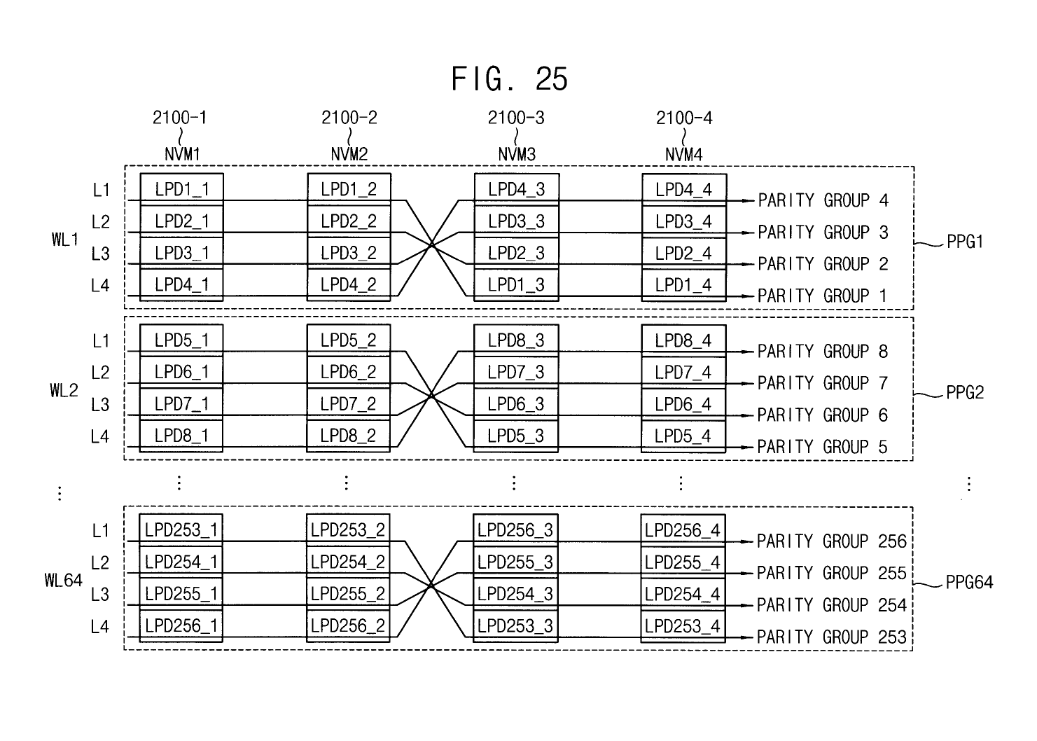

FIGS. 24 and 25 are diagrams further illustrating an operation of the SSD of FIG. 14 when physical pages included in a physical page group are coupled to a word line of the “same order”.

It is illustrated in FIGS. 24 and 25, that the SSD 2000 includes 1st through 4th non-volatile memory devices 2100-1, 2100-2, 2100-3 and 2100-4 (that is, N is again assumed to be four (4)) and the 2D flash memory cell array 2110 included in each of the 1st through 4th non-volatile memory devices 2100-1, 2100-2, 2100-3 and 2100-4 are coupled to 1st through 64th word lines WL1 to WL64, as an example.

FIG. 24 illustrates operation of the SSD 2000 when the level mix unit 2270 reverses the order of the M logical page data stored in the 4th physical page buffer 2240-4 as illustrated in FIG. 22.

Hereinafter, operation of the SSD 2000 will be described with reference to FIGS. 14 to 22 and 24.

The buffer memory 2220 may buffer data, which are received from the host, by a unit of a logical page and generate the 1st through the (N−1)th logical page data LPDi_1˜LPDi_(n−1). The parity generation unit 2230 may generate the Nth logical page data LPDi_n by performing the parity operation on the 1st through the (N−1)th logical page data LPDi_1˜LPDi_(n−1). The 1st through Nth logical page data LPDi_1˜LPDi_n may constitute a parity group. As illustrated in FIG. 21, the 1st through Nth physical page buffers 2240-1, 2240-2, . . . , 2240-n may receive the 1st through Nth logical page data LPDi_1˜LPDi_n, respectively, M times and store the 1st through Nth logical page data LPDi_1˜LPDi_n, respectively, M times in the received order.

The level mix unit 2270 may reverse the order of the M logical page data stored in one of the 1st through Nth physical page buffers 2240-1, 2240-2, . . . , 2240-n. That is, as illustrated in FIG. 22, the level mix unit 2270 may reverse the order of the M logical page data stored in the 4th physical page buffer 2240-4.

The control unit 2210 may determine the physical page group including the 1st through Nth physical pages that are selected from the 1st through Nth non-volatile memory devices 2100-1, 2100-2, . . . , 2100-n, respectively, such that the 1st through Nth physical pages are coupled to a word line of the same order.

For example, as illustrated in FIG. 24, the control unit 2210 may determine a 1st physical page group PPG1 by selecting a physical page coupled to a 1st word line WL1 from the 1st through 4th non-volatile memory devices 2100-1, 2100-2, 2100-3 and 2100-4, and store four (4) sets of the 1st through 4th logical page data LPD1_{—}1˜LPD1_{—}4, LPD2_{—}1˜LPD2_{—}4, LPD3_{—}1˜LPD3_{—}4 and LPD4_{—}1˜LPD4_{—}4, which are included in 1st through 4th parity groups PARITY GROUP 1, PARITY GROUP 2, PARITY GROUP 3 and PARITY GROUP 4 and stored in the 1st through 4th physical page buffers 2240-1, 2240-2, 2240-3 and 2240-4, respectively, in the 1st through 4th physical pages, respectively, included in the 1st physical page group PPG1.

As described above with reference to FIG. 22, the level mix unit 2270 may reverse the order of the M logical page data stored in the 4th physical page buffer 2240-4 before the control unit 2210 stores logical page data stored in the 1st through 4th physical page buffers 2240-1, 2240-2, 2240-3 and 2240-4 in the 1st through 4th non-volatile memory devices 2100-1, 2100-2, 2100-3 and 2100-4. Therefore, as illustrated in FIG. 24, 1st through 3rd logical page data LPD1_{—}1, LPD1_{—}2 and LPD1_{—}3 included in the 1st parity group PARITY GROUP1 may be stored in 1st level logical page L1, and 4th logical page data LPD1_{—}4 included in the 1st parity group PARITY GROUP1 may be stored in 4th level logical page L4. Similarly, 1st through 3rd logical page data LPD2_{—}1, LPD2_{—}2 and LPD2_{—}3 included in the 2nd parity group PARITY GROUP2 may be stored in 2nd level logical page L2, and 4th logical page data LPD2_{—}4 included in the 2nd parity group PARITY GROUP2 may be stored in 3rd level logical page L3. Similarly, 1st through 3rd logical page data LPD3_{—}1, LPD3_{—}2 and LPD3_{—}3 included in the 3rd parity group PARITY GROUP3 may be stored in 3rd level logical page L3, and 4th logical page data LPD3_{—}4 included in the 3rd parity group PARITY GROUP3 may be stored in 2nd level logical page L2. Similarly, 1st through 3rd logical page data LPD4_{—}1, LPD4_{—}2 and LPD4_{—}3 included in the 4th parity group PARITY GROUP4 may be stored in 4th level logical page L4, and 4th logical page data LPD4_{—}4 included in the 4th parity group PARITY GROUP4 may be stored in 1st level logical page L1.

And then, the control unit 2210 may determine a 2nd physical page group PPG2 by selecting a physical page coupled to a 2nd word line WL2 from the 1st through 4th non-volatile memory devices 2100-1, 2100-2, 2100-3 and 2100-4, and store four (4) sets of the 1st through 4th logical page data LPD5_{—}1˜LPD5_{—}4, LPD6_{—}1˜LPD6_{—}4, LPD7_{—}1˜LPD7_{—}4 and LPD8_{—}1˜LPD8_{—}4, which are included in 5th through 8th parity groups PARITY GROUP 5, PARITY GROUP 6, PARITY GROUP 7 and PARITY GROUP 8 and stored in the 1st through 4th physical page buffers 2240-1, 2240-2, 2240-3 and 2240-4, respectively, in the 1st through 4th physical pages, respectively, included in the 2nd physical page group PPG2. In this way, the control unit 2210 may determine a 64th physical page group PPG64 by selecting a physical page coupled to a 64th word line WL64 from the 1st through 4th non-volatile memory devices 2100-1, 2100-2, 2100-3 and 2100-4, and store four (4) sets of the 1st through 4th logical page data LPD253_{—}1˜LPD253_{—}4, LPD254_{—}1˜LPD254_{—}4, LPD255_{—}1˜LPD255_{—}4 and LPD256_{—}1˜LPD256_{—}4, which are included in 253rd through 256th parity groups PARITY GROUP 253, PARITY GROUP 254, PARITY GROUP 255 and PARITY GROUP 256 and stored in the 1st through 4th physical page buffers 2240-1, 2240-2, 2240-3 and 2240-4, respectively, in the 1st through 4th physical pages, respectively, included in the 64th physical page group PPG64.

FIG. 25 illustrates operation of the SSD 2000 when the level mix unit 2270 reverses the order of the M logical page data stored in the 3rd physical page buffer 2240-3 and the 4th physical page buffer 2240-4 as illustrated in FIG. 23.

Hereinafter, operation of the SSD 2000 will be described with reference to FIGS. 14 to 21, 23 and 25.

The buffer memory 2220 may buffer data, which are received from the host, by a unit of a logical page and generate the 1st through the (N−1)th logical page data LPDi_1˜LPDi_(n−1). The parity generation unit 2230 may generate the Nth logical page data LPDi_n by performing the parity operation on the 1st through the (N−1)th logical page data LPDi_1˜LPDi_(n−1). The 1st through Nth logical page data LPDi_1˜LPDi_n may constitute a parity group. As illustrated in FIG. 21, the 1st through Nth physical page buffers 2240-1, 2240-2, . . . , 2240-n may receive the 1st through Nth logical page data LPDi_1˜LPDi_n, respectively, M times and store the 1st through Nth logical page data LPDi_1˜LPDi_n, respectively, M times in the received order.

The level mix unit 2270 may reverse the order of the M logical page data stored in two of the 1st through Nth physical page buffers 2240-1, 2240-2, . . . , 2240-n. That is, as illustrated in FIG. 23, the level mix unit 2270 may reverse the order of the M logical page data stored in the 3rd physical page buffer 2240-3 and the 4th physical page buffer 2240-4.

The control unit 2210 may determine the physical page group including the 1st through Nth physical pages that are selected from the 1st through Nth non-volatile memory devices 2100-1, 2100-2, . . . , 2100-n, respectively, such that the 1st through Nth physical pages are coupled to a word line of the same order.

For example, as illustrated in FIG. 25, the control unit 2210 may determine a 1st physical page group PPG1 by selecting a physical page coupled to a 1st word line WL1 from the 1st through 4th non-volatile memory devices 2100-1, 2100-2, 2100-3 and 2100-4, and store four (4) sets of the 1st through 4th logical page data LPD1_{—}1˜LPD1_{—}4, LPD2_{—}1˜LPD2_{—}4, LPD3_{—}1˜LPD3_{—}4 and LPD4_{—}1˜LPD4_{—}4, which are included in 1st through 4th parity groups PARITY GROUP 1, PARITY GROUP 2, PARITY GROUP 3 and PARITY GROUP 4 and stored in the 1st through 4th physical page buffers 2240-1, 2240-2, 2240-3 and 2240-4, respectively, in the 1st through 4th physical pages, respectively, included in the 1st physical page group PPG1.

As described above with reference to FIG. 23, the level mix unit 2270 may reverse the order of the M logical page data stored in the 3rd physical page buffer 2240-3 and the 4th physical page buffer 2240-4 before the control unit 2210 stores logical page data stored in the 1st through 4th physical page buffers 2240-1, 2240-2, 2240-3 and 2240-4 in the 1st through 4th non-volatile memory devices 2100-1, 2100-2, 2100-3 and 2100-4. Therefore, as illustrated in FIG. 25, 1st and 2nd logical page data LPD1_{—}1 and LPD1_{—}2 included in the 1st parity group PARITY GROUP1 may be stored in 1st level logical page L1, and 3rd and 4th logical page data LPD1_{—}3 and LPD1_{—}4 included in the 1st parity group PARITY GROUP1 may be stored in 4th level logical page L4. Similarly, 1st and 2nd logical page data LPD2_{—}1 and LPD2_{—}2 included in the 2nd parity group PARITY GROUP2 may be stored in 2nd level logical page L2, and 3rd and 4th logical page data LPD2_{—}3 and LPD2_{—}4 included in the 2nd parity group PARITY GROUP2 may be stored in 3rd level logical page L3. Similarly, 1st and 2nd logical page data LPD3_{—}1 and LPD3_{—}2 included in the 3rd parity group PARITY GROUP3 may be stored in 3rd level logical page L3, and 3rd and 4th logical page data LPD3_{—}3 and LPD3_{—}4 included in the 3rd parity group PARITY GROUP3 may be stored in 2nd level logical page L2. Similarly, 1st and 2nd logical page data LPD4_{—}1 and LPD4_{—}2 included in the 4th parity group PARITY GROUP4 may be stored in 4th level logical page L4, and 3rd and 4th logical page data LPD4_{—}3 and LPD4_{—}4 included in the 4th parity group PARITY GROUP4 may be stored in 1st level logical page L1.

And then, the control unit 2210 may determine a 2nd physical page group PPG2 by selecting a physical page coupled to a 2nd word line WL2 from the 1st through 4th non-volatile memory devices 2100-1, 2100-2, 2100-3 and 2100-4, and store four (4) sets of the 1st through 4th logical page data LPD5_{—}1˜LPD5_{—}4, LPD6_{—}1˜LPD6_{—}4, LPD7_{—}1˜LPD7_{—}4 and LPD8_{—}1˜LPD8_{—}4, which are included in 5th through 8th parity groups PARITY GROUP 5, PARITY GROUP 6, PARITY GROUP 7 and PARITY GROUP 8 and stored in the 1st through 4th physical page buffers 2240-1, 2240-2, 2240-3 and 2240-4, respectively, in the 1st through 4th physical pages, respectively, included in the 2nd physical page group PPG2. In this way, the control unit 2210 may determine a 64th physical page group PPG64 by selecting a physical page coupled to a 64th word line WL64 from the 1st through 4th non-volatile memory devices 2100-1, 2100-2, 2100-3 and 2100-4, and store four (4) sets of the 1st through 4th logical page data LPD253_{—}1˜LPD253_{—}4, LPD254_{—}1˜LPD254_{—}4, LPD255_{—}1˜LPD255_{—}4 and LPD256_{—}1˜LPD256_{—}4, which are included in 253rd through 256th parity groups PARITY GROUP 253, PARITY GROUP 254, PARITY GROUP 255 and PARITY GROUP 256 and stored in the 1st through 4th physical page buffers 2240-1, 2240-2, 2240-3 and 2240-4, respectively, in the 1st through 4th physical pages, respectively, included in the 64th physical page group PPG64.

In the 2D flash memory cell array 2110, a physical page coupled to the 1st word line WL1 may have a relatively high bit error rate (BER) than physical pages coupled to other word lines. In other example embodiments, the control unit 2210 may determine the physical page group including the 1st through Nth physical pages that are selected from the 1st through Nth non-volatile memory devices 2100-1, 2100-2, . . . , 2100-n, respectively, such that at least two of the 1st through Nth physical pages are coupled to word lines of different orders. In this case, bit error rate (BER) imbalance between physical pages coupled to different word lines may be reduced.

For example, the control unit 2210 may determine a plurality of the physical page groups by selecting one physical page in an order from a physical page coupled to the 1st word line WL1 to a physical page coupled to the last word line WL64 from at least one of the 1st through Nth non-volatile memory devices 2100-1, 2100-2, . . . , 2100-n, and selecting a physical page coupled to the last word line WL64 at 1st and then selecting one physical page in an order from a physical page coupled to the 1st word line WL1 to a physical page coupled to the 2nd last word line WL63 from rest of the 1st through Nth non-volatile memory devices 2100-1, 2100-2, . . . , 2100-n.

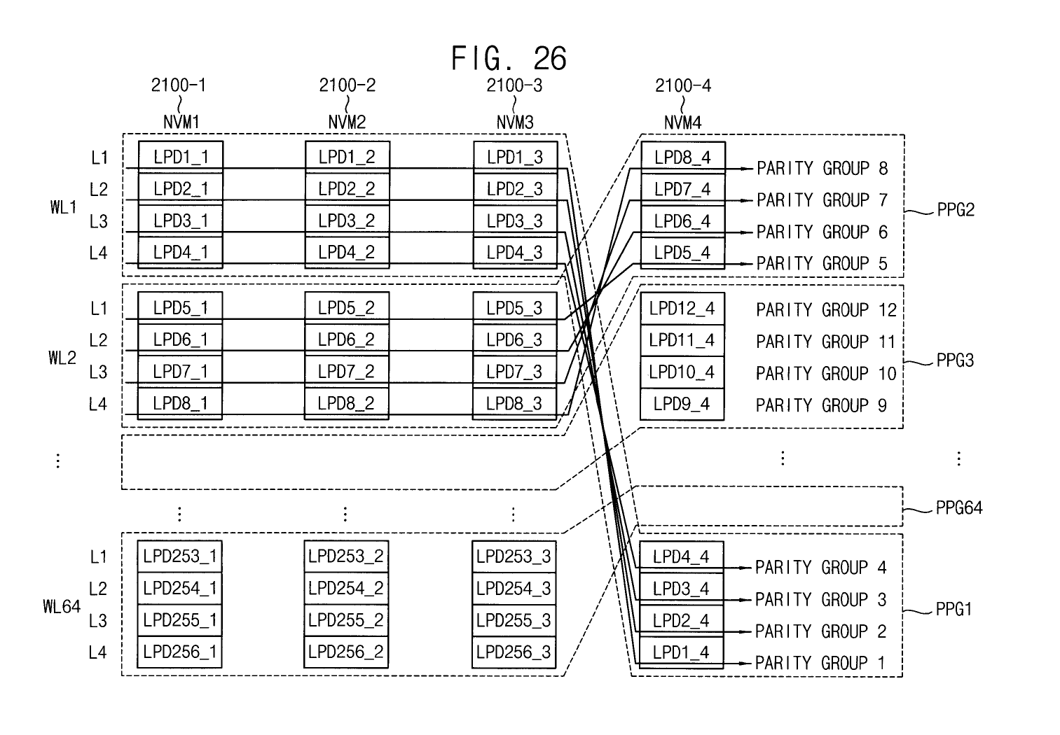

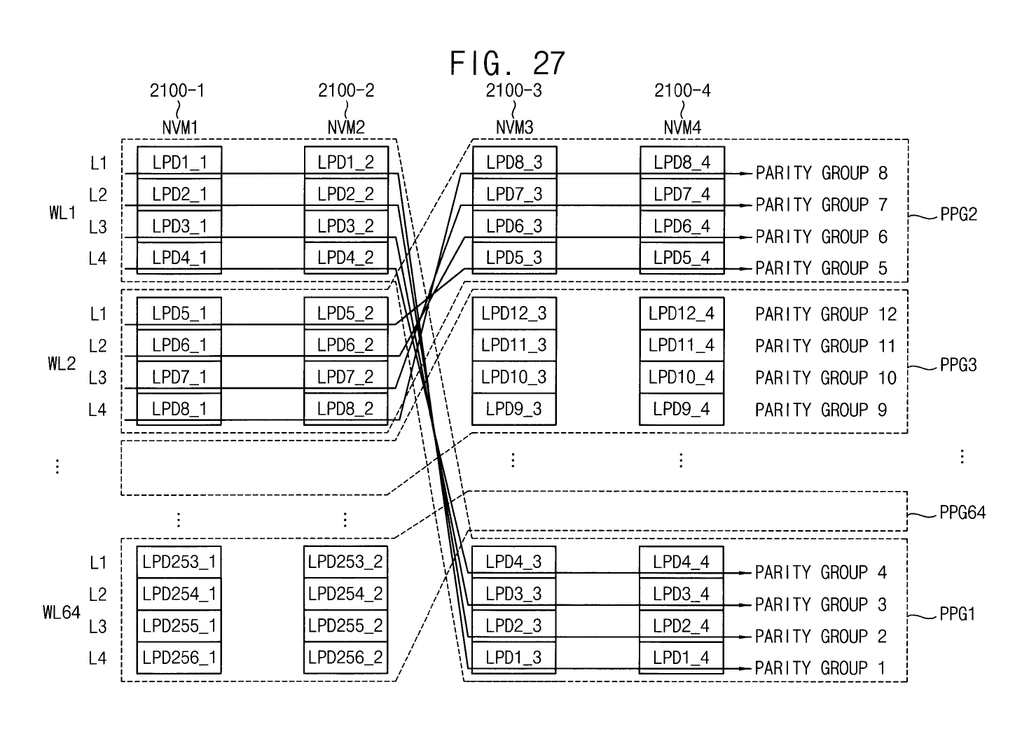

FIGS. 26 and 27 are diagrams further illustrating operation of the SSD of FIG. 14 when at least of two (2) physical pages included in a physical page group are coupled to word lines of “different orders”.

It is illustrated in FIGS. 26 and 27, that the SSD 2000 includes 1st through 4th non-volatile memory devices 2100-1, 2100-2, 2100-3 and 2100-4 (that is, N is again assumed to be four) and the 2D flash memory cell array 2110 included in each of the 1st through 4th non-volatile memory devices 2100-1, 2100-2, 2100-3 and 2100-4 are coupled to 1st through 64th word lines WL1 to WL64 as an example.

FIG. 26 illustrates operation of the SSD 2000 when the level mix unit 2270 reverses the order of the M logical page data stored in the 4th physical page buffer 2240-4 as illustrated in FIG. 22.

Hereinafter, operation of the SSD 2000 will be described with reference to FIGS. 14 to 22 and 26.

The buffer memory 2220 may buffer data, which are received from the host, by a unit of a logical page and generate the 1st through the (N−1)th logical page data LPDi_1˜LPDi_(n−1). The parity generation unit 2230 may generate the Nth logical page data LPDi_n by performing the parity operation on the 1st through the (N−1)th logical page data LPDi_1˜LPDi_(n−1). The 1st through Nth logical page data LPDi_1˜LPDi_n may constitute a parity group. As illustrated in FIG. 21, the 1st through Nth physical page buffers 2240-1, 2240-2, . . . , 2240-n may receive the 1st through Nth logical page data LPDi_1˜LPDi_n, respectively, M times and store the 1st through Nth logical page data LPDi_1˜LPDi_n, respectively, M times in the received order.

The level mix unit 2270 may reverse the order of the M logical page data stored in one of the 1st through Nth physical page buffers 2240-1, 2240-2, . . . , 2240-n. That is, as illustrated in FIG. 22, the level mix unit 2270 may reverse the order of the M logical page data stored in the 4th physical page buffer 2240-4.

The control unit 2210 may determine the physical page group including the 1st through Nth physical pages that are selected from the 1st through Nth non-volatile memory devices 2100-1, 2100-2, . . . , 2100-n, respectively, such that at least two of the 1st through Nth physical pages are coupled to word lines of different orders.

For example, as illustrated in FIG. 26, the control unit 2210 may determine a 1st physical page group PPG1 by selecting a physical page coupled to a 1st word line WL1 from the 1st through the 3rd non-volatile memory devices 2100-1, 2100-2 and 2100-3 and selecting a physical page coupled to a 64th word line WL64 from the 4th non-volatile memory devices 2100-4. The control unit 2210 may store four (4) sets of the 1st through the 3rd logical page data LPD1_{—}1˜LPD1_{—}3, LPD2_{—}1˜LPD2_{—}3, LPD3_{—}1˜LPD3_{—}3 and LPD4_{—}1˜LPD4_{—}3, which are included in 1st through 4th parity groups PARITY GROUP 1, PARITY GROUP 2, PARITY GROUP 3 and PARITY GROUP 4 and stored in the 1st through the 3rd physical page buffers 2240-1, 2240-2 and 2240-3, respectively, in the 1st through the 3rd physical pages, respectively, included in the 1st physical page group PPG1. Since the program operation is sequentially performed on from a physical page coupled to the 1st word line WL1 to a physical page coupled to the last word line WL64 in the 2D flash memory cell array 2110, the control unit 2210 may store four (4) sets of the 4th logical page data LPD1_{—}4, LPD2_{—}4, LPD3_{—}4 and LPD4_{—}4, which are included in 1st through 4th parity groups PARITY GROUP 1, PARITY GROUP 2, PARITY GROUP 3 and PARITY GROUP 4, respectively, and stored in the 4th physical page buffer 2240-4, in a temporary memory (not illustrated) without storing in a physical page coupled to the last word line WL64 of the 4th non-volatile memory devices 2100-4.

And then, the control unit 2210 may determine a 2nd physical page group PPG2 by selecting a physical page coupled to a 2nd word line WL2 from the 1st through the 3rd non-volatile memory devices 2100-1, 2100-2 and 2100-3 and selecting a physical page coupled to a 1st word line WL1 from the 4th non-volatile memory devices 2100-4, and store four (4) sets of the 1st through 4th logical page data LPD5_{—}1˜LPD5_{—}4, LPD6_{—}1˜LPD6_{—}4, LPD7_{—}1˜LPD7_{—}4 and LPD8_{—}1˜LPD8_{—}4, which are included in 5th through 8th parity groups PARITY GROUP 5, PARITY GROUP 6, PARITY GROUP 7 and PARITY GROUP 8 and stored in the 1st through 4th physical page buffers 2240-1, 2240-2, 2240-3 and 2240-4, respectively, in the 1st through 4th physical pages, respectively, included in the 2nd physical page group PPG2.

As described above with reference to FIG. 22, the level mix unit 2270 may reverse the order of the M logical page data stored in the 4th physical page buffer 2240-4 before the control unit 2210 stores logical page data stored in the 1st through 4th physical page buffers 2240-1, 2240-2, 2240-3 and 2240-4 in the 1st through 4th non-volatile memory devices 2100-1, 2100-2, 2100-3 and 2100-4. Therefore, as illustrated in FIG. 26, 1st through 3rd logical page data LPD5_{—}1, LPD5_{—}2 and LPD5_{—}3 included in the 5th parity group PARITY GROUP5 may be stored in 1st level logical page L1, and 4th logical page data LPD5_{—}4 included in the 5th parity group PARITY GROUP5 may be stored in 4th level logical page L4. Similarly, 1st through 3rd logical page data LPD6_{—}1, LPD6_{—}2 and LPD6_{—}3 included in the 5th parity group PARITY GROUP6 may be stored in 2nd level logical page L2, and 4th logical page data LPD6_{—}4 included in the 5th parity group PARITY GROUP6 may be stored in 3rd level logical page L3. Similarly, 1st through 3rd logical page data LPD7_{—}1, LPD7_{—}2 and LPD7_{—}3 included in the 7th parity group PARITY GROUP7 may be stored in 3rd level logical page L3, and 4th logical page data LPD7_{—}4 included in the seventh parity group PARITY GROUP7 may be stored in 2nd level logical page L2. Similarly, 1st through 3rd logical page data LPD8_{—}1, LPD8_{—}2 and LPD8_{—}3 included in the 8th parity group PARITY GROUP8 may be stored in 4th level logical page L4, and 4th logical page data LPD8_{—}4 included in the 8th parity group PARITY GROUP8 may be stored in 1st level logical page L1.

In similar manner, the control unit 2210 may determine 3rd through 63rd physical page groups PPG3 to PPG63 by selecting one physical page in an order from a physical page coupled to a 3rd word line WL3 to a physical page coupled to a 63rd word line WL63 from the 1st through 3rd non-volatile memory devices 2100-1, 2100-2 and 2100-3 and selecting one physical page in an order from a physical page coupled to a 2nd word line WL2 to a physical page coupled to a 62nd word line WL62 from the 4th non-volatile memory device 2100-4, and store four (4) sets of the 1st through 4th logical page data LPDi_1˜LPDi_4 in the 1st through 4th physical pages, respectively, included in a corresponding physical page group.

Then, the control unit 2210 may determine a 64th physical page group PPG64 by selecting a physical page coupled to a 64th word line WL64 from the 1st through 3rd non-volatile memory devices 2100-1, 2100-2 and 2100-3 and selecting a physical page coupled to the 63rd word line WL63 from the 4th non-volatile memory devices 2100-4, and store four (4) sets of the 1st through 4th logical page data LPD253_{—1}˜LPD253_{—}4, LPD254_{—}1˜LPD254_{—}4, LPD255_{—}1˜LPD255_{—}4 and LPD256_{—}1˜LPD256_{—}4, which are included in 253rd through 256th parity groups PARITY GROUP 253, PARITY GROUP 254, PARITY GROUP 255 and PARITY GROUP 256 and stored in the 1st through 4th physical page buffers 2240-1, 2240-2, 2240-3 and 2240-4 in the 1st through 4th physical pages, respectively, included in a 64th physical page group PPG64.

Then, the control unit 2210 may store four (4) sets of the 4th logical page data LPD1_{—}4, LPD2_{—}4, LPD3_{—}4 and LPD4_{—}4 included in 1st through 4th parity groups PARITY GROUP 1, PARITY GROUP 2, PARITY GROUP 3 and PARITY GROUP 4, respectively, and stored in the temporary memory (not illustrated), in a physical page that is included in the 1st physical page group PPG1 and is coupled to the last word line WL64 of the 4th non-volatile memory devices 2100-4.

FIG. 27 illustrates operation of the SSD 2000 when the level mix unit 2270 reverses the order of the M logical page data stored in the 3rd physical page buffer 2240-3 and the 4th physical page buffer 2240-4 as illustrated in FIG. 23.

Hereinafter, operation of the SSD 2000 will be described with reference to FIGS. 14 to 21, 23 and 27.

The buffer memory 2220 may buffer data, which are received from the host, by a unit of a logical page and generate the 1st through (N−1)th logical page data LPDi_1˜LPDi_(n−1). The parity generation unit 2230 may generate the Nth logical page data LPDi_n by performing the parity operation on the 1st through (N−1)th logical page data LPDi_1˜LPDi_(n−1). The 1st through Nth logical page data LPDi_1˜LPDi_n may constitute a parity group. As illustrated in FIG. 21, the 1st through Nth physical page buffers 2240-1, 2240-2, . . . , 2240-n may receive the 1st through Nth logical page data LPDi_1˜LPDi_n, respectively, M times and store the 1st through Nth logical page data LPDi_1˜LPDi_n, respectively, M times in the received order.

The level mix unit 2270 may reverse the order of the M logical page data stored in two of the 1st through Nth physical page buffers 2240-1, 2240-2, . . . , 2240-n. That is, as illustrated in FIG. 23, the level mix unit 2270 may reverse the order of the M logical page data stored in the 3rd physical page buffer 2240-3 and the 4th physical page buffer 2240-4.

The control unit 2210 may determine the physical page group including the 1st through Nth physical pages that are selected from the 1st through Nth non-volatile memory devices 2100-1, 2100-2, . . . , 2100-n, respectively, such that at least two (2) of the 1st through Nth physical pages are coupled to word lines having different orders.

For example, as illustrated in FIG. 27, the control unit 2210 may determine a 1st physical page group PPG1 by selecting a physical page coupled to a 1st word line WL1 from the 1st and 2nd non-volatile memory devices 2100-1 and 2100-2 and selecting a physical page coupled to a 64th word line WL64 from the 3rd and 4th non-volatile memory devices 2100-3 and 2100-4. The control unit 2210 may store four (4) sets of the 1st and the 2nd logical page data LPD1_{—}1˜LPD1_{—}2, LPD2_{—}1˜LPD2_{—}2, LPD3_{—}1˜LPD3_{—}2 and LPD4_{—}1˜LPD4_{—}2, which are included in 1st through 4th parity groups PARITY GROUP 1, PARITY GROUP 2, PARITY GROUP 3 and PARITY GROUP 4 and stored in the 1st and 2nd physical page buffers 2240-1 and 2240-2, respectively, in the 1st and 2nd physical pages, respectively, included in the 1st physical page group PPG1. Since a program operation may be sequentially performed from a physical page coupled to the 1st word line WL1 to a physical page coupled to the last word line WL64 in the 2D flash memory cell array 2110, the control unit 2210 may store four (4) sets of the 3rd and the 4th logical page data LPD1_{—}3˜LPD1_{—}4, LPD2_{—}3˜LPD2_{—}4, LPD3_{—}3˜LPD3_{—}4 and LPD4_{—}3˜LPD4_{—}4, which are included in the 1st through 4th parity groups PARITY GROUP 1, PARITY GROUP 2, PARITY GROUP 3 and PARITY GROUP 4, respectively, and stored in the 3rd and 4th physical page buffers 2240-3 and 2240-4, in a temporary memory (not illustrated) without storing in physical pages coupled to a 64^{th} (e.g., a last) word line WL64 of the 3rd and 4th non-volatile memory devices 2100-3 and 2100-4.

Then, the control unit 2210 may determine a 2nd physical page group PPG2 by selecting a physical page coupled to a 2nd word line WL2 from the 1st and 2nd non-volatile memory devices 2100-1 and 2100-2 and selecting a physical page coupled to a 1st word line WL1 from the 3rd and 4th non-volatile memory devices 2100-3 and 2100-4, and store four (4) sets of the 1st through 4th logical page data LPD5_{—}1˜LPD5_{—}4, LPD6_{—}1˜LPD6_{—}4, LPD7_{—}1˜LPD7_{—}4 and LPD8_{—}1˜LPD8_{—}4, which are included in 5th through 8th parity groups PARITY GROUP 5, PARITY GROUP 6, PARITY GROUP 7 and PARITY GROUP 8 and stored in the 1st through 4th physical page buffers 2240-1, 2240-2, 2240-3 and 2240-4, respectively, in the 1st through 4th physical pages, respectively, included in the 2nd physical page group PPG2.

As described above with reference to FIG. 23, the level mix unit 2270 may reverse the order of the M logical page data stored in the 3rd and 4th physical page buffers 2240-3 and 2240-4 before the control unit 2210 stores logical page data stored in the 1st through 4th physical page buffers 2240-1, 2240-2, 2240-3 and 2240-4 in the 1st through 4th non-volatile memory devices 2100-1, 2100-2, 2100-3 and 2100-4. Therefore, as illustrated in FIG. 27, 1st and 2nd logical page data LPD5_{—}1 and LPD5_{—}2 included in the 5th parity group PARITY GROUP5 may be stored in 1st level logical page L1, and 3rd and 4th logical page data LPD5_{—}3 and LPD5_{—}4 included in the 5th parity group PARITY GROUP5 may be stored in 4th level logical page L4. Similarly, 1st and 2nd logical page data LPD6_{—}1 and LPD6_{—}2 included in the 5th parity group PARITY GROUP6 may be stored in 2nd level logical page L2, and 3rd and 4th logical page data LPD6_{—}3 and LPD6_{—}4 included in the sixth parity group PARITY GROUP6 may be stored in 3rd level logical page L3. Similarly, 1st and 2nd logical page data LPD7_{—}1 and LPD7_{—}2 included in the 7th parity group PARITY GROUP7 may be stored in 3rd level logical page L3, and 3rd and 4th logical page data LPD7_{—}3 and LPD7_{—}4 included in the 7th parity group PARITY GROUP7 may be stored in 2nd level logical page L2. Similarly, 1st and 2nd logical page data LPD8_{—}1 and LPD8_{—}2 included in the 8th parity group PARITY GROUP8 may be stored in 4th level logical page L4, and 3rd and 4th logical page data LPD8_{—}3 and LPD8_{—}4 included in the 8th parity group PARITY GROUP8 may be stored in 1st level logical page L1.

In similar manner, the control unit 2210 may determine 3rd through 63rd physical page groups PPG3 to PPG63 by selecting one physical page in an order from a physical page coupled to a 3rd word line WL3 to a physical page coupled to a 63rd word line WL63 from the 1st and 2nd non-volatile memory devices 2100-1 and 2100-2 and selecting one physical page in an order from a physical page coupled to a 2nd word line WL2 to a physical page coupled to a 62nd word line WL62 from the 3rd and 4th non-volatile memory device 2100-3 and 2100-4, and store four (4) sets of the 1st through 4th logical page data LPDi_1˜LPDi_4 in the 1st through 4th physical pages, respectively, included in a corresponding physical page group.

Then, the control unit 2210 may determine a 64th physical page group PPG64 by selecting a physical page coupled to a 64th word line WL64 from the 1st and 2nd non-volatile memory devices 2100-1 and 2100-2 and selecting a physical page coupled to a 63rd word line WL63 from the 3rd and 4th non-volatile memory devices 2100-3 and 2100-4, and store four (4) sets of the 1st through 4th logical page data LPD253_{—}1˜LPD253_{—}4, LPD254_{—}1˜LPD254_{—}4, LPD255_{—}1˜LPD255_{—}4 and LPD256_{—}1˜LPD256_{—}4, which are included in 253rd through 256th parity groups PARITY GROUP 253, PARITY GROUP 254, PARITY GROUP 255 and PARITY GROUP 256 and stored in the 1st through 4th physical page buffers 2240-1, 2240-2, 2240-3 and 2240-4, respectively, in the 1st through 4th physical pages, respectively, included in a 64th physical page group PPG64.

Then, the control unit 2210 may store four (4) sets of the 3rd and 4th logical page data LPD1_{—}3˜LPD1_{—}4, LPD2_{—}3˜LPD2_{—}4, LPD3_{—}3˜LPD3_{—}4 and LPD4_{—}3˜LPD4_{—}4 included in 1st through 4th parity groups PARITY GROUP 1, PARITY GROUP 2, PARITY GROUP 3 and PARITY GROUP 4, respectively, and stored in the temporary memory (not illustrated), in physical pages that are included in the 1st physical page group PPG1 and are coupled to the last word line WL64 of the 3rd and 4th non-volatile memory devices 2100-3 and 2100-4.

As described above, the SSD 2000 determines the logical page group including the 1st through Nth logical pages, such that at least two (2) of the 1st through Nth logical pages included in the logical page group are of different levels, and stores the 1st through Nth logical page data LPDi_1˜LPDi_n included in the same parity group in the 1st through Nth logical pages included in the logical page group, respectively. Therefore, the data recovery rate imbalance between parity groups may be decreased, and the number of times the SSD 2000 may not be able to recover damaged data may also be decreased. In other words, the SSD 2000 may increase overall stability.

Furthermore, the SSD 2000 may store the 1st through Nth logical page data LPDi_1˜LPDi_n included in the same parity group in a dispersed manner across physical pages coupled to word lines of different orders, such that the data recovery rate imbalance between parity groups is decreased and overall data recovery rate of the SSD 2000 increased.

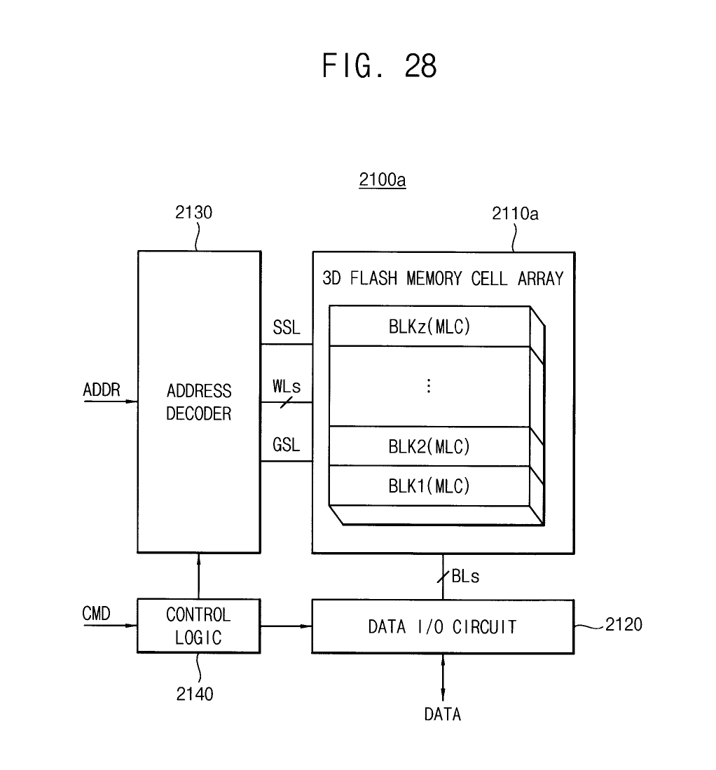

FIG. 28 is a block diagram illustrating another example of a non-volatile memory device that may be included in the SSD of FIG. 14.

The 1st through Nth non-volatile memory devices 2100-1, 2100-2, . . . , 2100-n included in the SSD 2000 of FIG. 14 may be embodied as a flash memory device 2100a of FIG. 28.

Referring to FIG. 28, the flash memory device 2100a may include a three-dimensional (3D) flash memory cell array 2110a, a data input/output (I/O) circuit 2120, an address decoder 2130 and a control logic 2140.

The 3D flash memory cell array 2110a may be formed on a substrate in a 3D or vertical structure. The 3D flash memory cell array 2110a may include a plurality of physical pages coupled to a plurality of word lines WLs formed in order on the substrate such that heights of the plurality of word lines WLs are different.

The 3D flash memory cell array 2110a may include a plurality of memory blocks BLK1, BLK2, . . . , BLKz. Here, z is a positive integer. Each of the plurality of memory blocks BLK1, BLK2, . . . , BLKz may include a plurality of physical pages. Each of the plurality of physical pages may include a plurality of multi-level cells. Each of the plurality of multi-level cells may store M-bit data. Therefore, each of the plurality of physical pages included in the 3D flash memory cell array 2110a may include M logical pages, which are called as the 1st level through the Mth level logical pages. The 3D flash memory cell array 2110a may perform a program operation and a read operation on a unit basis of a physical page and perform an erase operation on a unit basis of a memory block.

The structure and operation of the 3D flash memory cell array 1110 has been described above with reference to FIGS. 3 to 8, and an operation of the multi-level cell has been described above with reference to FIGS. 16 to 20. Therefore, a detailed description of the 3D flash memory cell array 2110a in FIG. 28 will be omitted here.

The data I/O circuit 2120 may be connected to the 3D flash memory cell array 2110a through a plurality of bit lines BLs. The data I/O circuit 2120 may receive data (DATA) from the RAID controller 2200 and output data (DATA) read from the 3D flash memory cell array 2110a to the RAID controller 2200.

The address decoder 2130 may be connected to the 3D flash memory cell array 2110a through the plurality of word lines WLs, a string selection line SSL, and a ground selection line GSL. The address decoder 2130 may receive an address ADDR from the RAID controller 2200 and select a word line.

The control logic 2140 may control the program operation, the read operation, and the erase operation of the flash memory device 2100a by controlling the data I/O circuit 2120 and the address decoder 2130 based on a control signal CMD received from the RAID controller 2200. For example, in the program operation, the control logic 2140 may control the address decoder 2130 to allow a program voltage to be provided to a selected word line, and control the data I/O circuit 2120 to allow data to be programmed in memory cells connected to the selected word line.

As described above with reference to FIGS. 2 to 8, when each of the 1st through Nth non-volatile memory devices 2100-1, 2100-2, . . . , 2100-n includes the 3D flash memory cell array 2110a, physical pages coupled to word lines at different heights in the 2D memory cell array may have different bit error rates (BERs). Therefore, in order to reduce a bit error rate (BER) imbalance between parity groups, the control unit 2210 may determine the physical page group including the 1st through Nth physical pages such that at least two (2) of the 1st through Nth physical pages are coupled to word lines of different heights in the 3D memory cell array.

In some example embodiments, the control unit 2210 may select a 1st word line having a 1st height and a 2nd word line having a 2nd height different from the 1st height in the 3D memory cell array from among the plurality of word lines WLs, and select one of a physical page coupled to the 1st word line and a physical page coupled to the 2nd word line from each of the 1st through Nth non-volatile memory devices 2100-1, 2100-2, . . . , 2100-n to determine the physical page group. In this case, at least one of the 1st through Nth physical pages included in the physical page group may be coupled to the 1st word line and a remainder of the 1st through Nth physical pages included in the physical page group may be coupled to the 2nd word line.

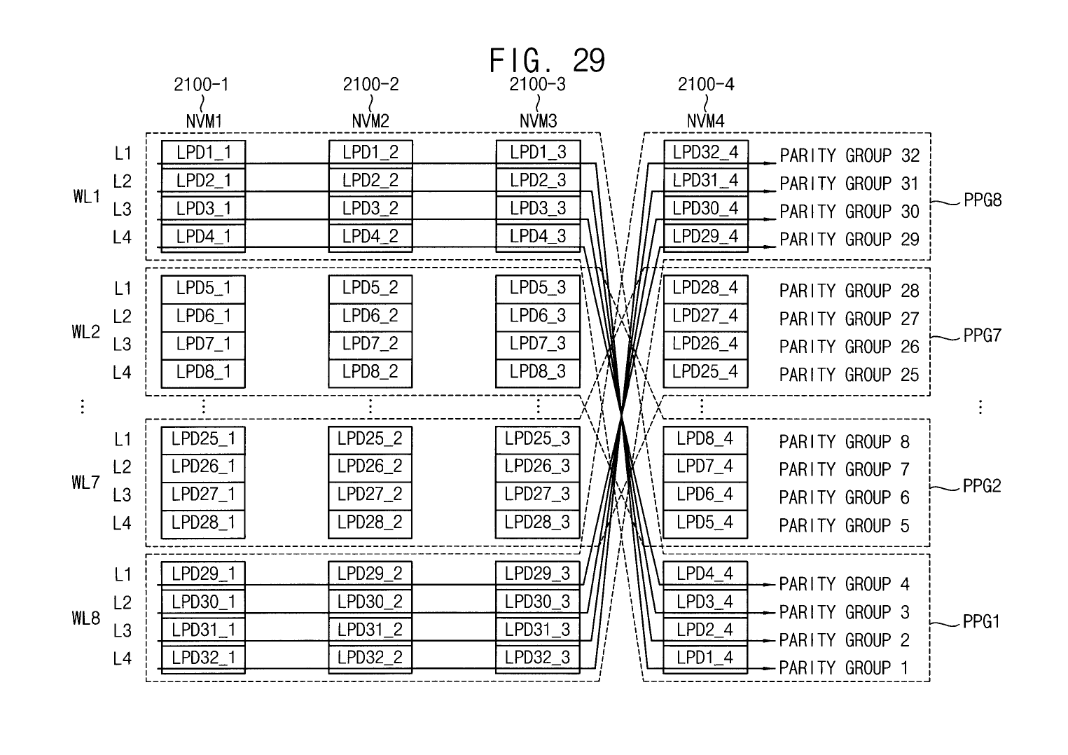

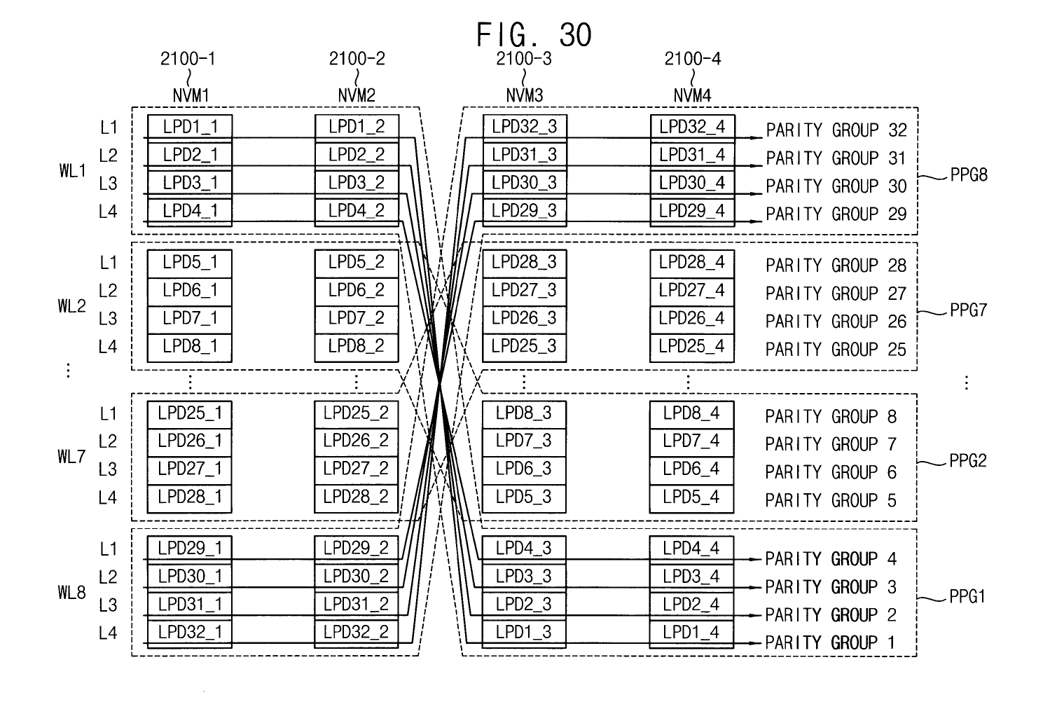

FIGS. 29 and 30 are diagrams further illustrating operation of the SSD of FIG. 14 when the SSD includes the flash memory device of FIG. 28.

It is illustrated in FIGS. 29 and 30, that the SSD 2000 includes 1st through 4th non-volatile memory devices 2100-1, 2100-2, 2100-3 and 2100-4 (again, N is assumed to be four) and the 3D flash memory cell array 2110a included in each of the 1st through 4th non-volatile memory devices 2100-1, 2100-2, 2100-3 and 2100-4 are coupled to 1st through 8th word lines WL1 to WL8 as an example.

FIG. 29 illustrates operation of the SSD 2000 when the level mix unit 2270 reverses the order of the M logical page data stored in the 4th physical page buffer 2240-4 as illustrated in FIG. 22.

Hereinafter, operation of the SSD 2000 will be described with reference to FIGS. 14, 21, 22 and 29.

The buffer memory 2220 may buffer data received from the host on a logical page basis in order to generate 1st through (N−1)th logical page data LPDi_1˜LPDi_(n−1). The parity generation unit 2230 may generate an Nth logical page data LPDi_n by performing the parity operation on the 1st through (N−1)th logical page data LPDi_1˜LPDi_(n−1). The 1st through Nth logical page data LPDi_1˜LPDi_n constitute a parity group. As illustrated in FIG. 21, the 1st through Nth physical page buffers 2240-1, 2240-2, . . . , 2240-n may receive the 1st through Nth logical page data LPDi_1˜LPDi_n, respectively, M times and store the 1st through Nth logical page data LPDi_1˜LPDi_n, respectively, M times in the received order.

The level mix unit 2270 may reverse the order of the M logical page data stored in one of the 1st through Nth physical page buffers 2240-1, 2240-2, . . . , 2240-n. That is, as illustrated in FIG. 22, the level mix unit 2270 may reverse the order of the M logical page data stored in the 4th physical page buffer 2240-4.

The control unit 2210 may determine a plurality of the physical page groups by selecting one physical page in an order from a physical page coupled to a lowest word line in the memory cell array to a physical page coupled to a highest word line in the memory cell array from at least one of the 1st through Nth non-volatile memory devices 2100-1, 2100-2, . . . , 2100-n and selecting one physical page in an order from a physical page coupled to the highest word line in the memory cell array to a physical page coupled to the lowest word line in the memory cell array from a remainder of the 1st through Nth non-volatile memory devices 2100-1, 2100-2, . . . , 2100-n.

In some example embodiments, as illustrated in FIG. 29, the control unit 2210 may determine a plurality of the physical page groups PPG1 to PPG8 by selecting one physical page in an order from a physical page coupled to the lowest word line WL1 to a physical page coupled to the highest word line WL8 from the 1st, 2nd and 3rd non-volatile memory devices 2100-1, 2100-2 and 2100-3 and selecting one physical page in an order from a physical page coupled to the highest word line WL8 to a physical page coupled to the lowest word line WL1 from the 4th non-volatile memory device 2100-4.

In this case, the control unit 2210 may determine a 1st physical page group PPG1 by selecting a physical page coupled to a 1st word line WL1 from the 1st, 2nd and 3rd non-volatile memory devices 2100-1, 2100-2 and 2100-3 and selecting a physical page coupled to the 8th word line WL8 from the 4th non-volatile memory device 2100-4, and store four (4) sets of the 1st through 4th logical page data LPD1_{—}1˜LPD1_{—}4, LPD2_{—}1˜LPD2_{—}4, LPD3_{—}1˜LPD3_{—}4 and LPD4_{—}1˜LPD4_{—}4, which are included in 1st through 4th parity groups PARITY GROUP 1, PARITY GROUP 2, PARITY GROUP 3 and PARITY GROUP 4 and stored in the 1st through 4th physical page buffers 2240-1, 2240-2, 2240-3 and 2240-4, respectively, in the 1st through 4th physical pages, respectively, included in the 1st physical page group PPG1.

As described above with reference to FIG. 22, the level mix unit 2270 may reverse the order of the M logical page data stored in the 4th physical page buffer 2240-4 before the control unit 2210 stores logical page data stored in the 1st through 4th physical page buffers 2240-1, 2240-2, 2240-3 and 2240-4 in the 1st through 4th non-volatile memory devices 2100-1, 2100-2, 2100-3 and 2100-4. Therefore, as illustrated in FIG. 29, 1st through 3rd logical page data LPD1_{—}1, LPD1_{—}2 and LPD1_{—}3 included in the 1st parity group PARITY GROUP1 may be stored in 1st level logical page L1, and 4th logical page data LPD1_{—}4 included in the 1st parity group PARITY GROUP1 may be stored in 4th level logical page L4. Similarly, 1st through 3rd logical page data LPD2_{—}1, LPD2_{—}2 and LPD2_{—}3 included in the 2nd parity group PARITY GROUP2 may be stored in 2nd level logical page L2, and 4th logical page data LPD2_{—}4 included in the 2nd parity group PARITY GROUP2 may be stored in 3rd level logical page L3. Similarly, 1st through 3rd logical page data LPD3_{—}1, LPD3_{—}2 and LPD3_{—}3 included in the 3rd parity group PARITY GROUP3 may be stored in 3rd level logical page L3, and 4th logical page data LPD3_{—}4 included in the 3rd parity group PARITY GROUP3 may be stored in 2nd level logical page L2. Similarly, 1st through 3rd logical page data LPD4_{—}1, LPD4_{—}2 and LPD4_{—}3 included in the 4th parity group PARITY GROUP4 may be stored in 4th level logical page L4, and 4th logical page data LPD4_{—}4 included in the 4th parity group PARITY GROUP4 may be stored in 1st level logical page L1.

In similar manner, the control unit 2210 may determine 2nd through 7th physical page groups PPG2 to PPG7 by selecting one physical page in an order from a physical page coupled to a 2nd word line WL2 to a physical page coupled to a 7th word line WL7 from the 1st through the 3rd non-volatile memory devices 2100-1, 2100-2 and 2100-3 and selecting one physical page in an order from a physical page coupled to a 7th word line WL7 to a physical page coupled to a 2nd word line WL2 from the 4th non-volatile memory device 2100-4, and store four (4) sets of the 1st through 4th logical page data LPDi_1˜LPDi_4 in the 1st through 4th physical pages, respectively, included in a corresponding physical page group.

Then, the control unit 2210 may determine an 8th physical page group PPG8 by selecting a physical page coupled to an 8th word line WL8 from the 1st, the 2nd and the 3rd non-volatile memory devices 2100-1, 2100-2 and 2100-3 and selecting a physical page coupled to a 1st word line WL1 from the 4th non-volatile memory device 2100-4, and store four (4) sets of the 1st through 4th logical page data LPD29_{—}1˜LPD29_{—}4, LPD30_{—}1˜LPD30_{—}4, LPD31_{—}1˜LPD31_{—}4 and LPD32_{—}1˜LPD32_{—}4, which are included in the 29th through 32rd parity groups PARITY GROUP 29, PARITY GROUP 30, PARITY GROUP 31 and PARITY GROUP 32 and stored in the 1st through 4th physical page buffers 2240-1, 2240-2, 2240-3 and 2240-4, respectively, in the 1st through 4th physical pages, respectively, included in the 8th physical page group PPG8.

FIG. 30 illustrates operation of the SSD 2000 when the level mix unit 2270 reverses the order of the M logical page data stored in the 3rd physical page buffer 2240-3 and 4th physical page buffer 2240-4 as illustrated in FIG. 23.

Hereinafter, operation of the SSD 2000 will be described with reference to FIGS. 14, 21, 23 and 30.

The buffer memory 2220 may buffer data received from the host on a logical page basis in order to generate the 1st through (N−1)th logical page data LPDi_1˜LPDi_(n−1). The parity generation unit 2230 may generate the Nth logical page data LPDi_n by performing the parity operation on the 1st through (N−1)th logical page data LPDi_1˜LPDi_(n−1). The 1st through Nth logical page data LPDi_1˜LPDi_n constitutes a parity group. As illustrated in FIG. 21, the 1st through Nth physical page buffers 2240-1, 2240-2, . . . , 2240-n may receive the 1st through Nth logical page data LPDi_1˜LPDi_n, respectively, M times and store the 1st through Nth logical page data LPDi_1˜LPDi_n, respectively, M times in the received order.

The level mix unit 2270 may reverse the order of the M logical page data stored in two of the 1st through Nth physical page buffers 2240-1, 2240-2, . . . , 2240-n. That is, as illustrated in FIG. 23, the level mix unit 2270 may reverse the order of the M logical page data stored in the 3rd physical page buffer 2240-3 and the 4th physical page buffer 2240-4.

The control unit 2210 may determine a plurality of the physical page groups by selecting one physical page in an order from a physical page coupled to a lowest word line to a physical page coupled to a highest word line from at least one of the 1st through Nth non-volatile memory devices 2100-1, 2100-2, . . . , 2100-n and selecting one physical page in an order from a physical page coupled to the highest word line to a physical page coupled to the lowest word line from a remainder of the 1st through Nth non-volatile memory devices 2100-1, 2100-2, . . . , 2100-n.

In some example embodiments, as illustrated in FIG. 30, the control unit 2210 may determine a plurality of the physical page groups PPG1 to PPG8 by selecting one physical page in an order from a physical page coupled to a lowest word line WL1 to a physical page coupled to a highest word line WL8 from the 1st and 2nd non-volatile memory devices 2100-1 and 2100-2 and selecting one physical page in an order from a physical page coupled to the highest word line WL8 to a physical page coupled to the lowest word line WL1 from the 3rd and the 4th non-volatile memory devices 2100-3 and 2100-4.

In this case, the control unit 2210 may determine a 1st physical page group PPG1 by selecting a physical page coupled to a 1st word line WL1 from the 1st and 2nd non-volatile memory devices 2100-1 and 2100-2 and selecting a physical page coupled to an 8th word line WL8 from the 3rd and the 4th non-volatile memory devices 2100-3 and 2100-4, and store four (4) sets of the 1st through 4th logical page data LPD1_{—}1˜LPD1_{—}4, LPD2_{—}1˜LPD2_{—}4, LPD3_{—}1˜LPD3_{—}4 and LPD4_{—}1˜LPD4_{—}4, which are included in 1st through 4th parity groups PARITY GROUP 1, PARITY GROUP 2, PARITY GROUP 3 and PARITY GROUP 4 and stored in the 1st through 4th physical page buffers 2240-1, 2240-2, 2240-3 and 2240-4, respectively, in the 1st through 4th physical pages, respectively, included in the 1st physical page group PPG1.

As described above with reference to FIG. 23, the level mix unit 2270 may reverse the order of the M logical page data stored in the 3rd physical page buffer 2240-3 and the 4th physical page buffer 2240-4 before the control unit 2210 stores logical page data stored in the 1st through 4th physical page buffers 2240-1, 2240-2, 2240-3 and 2240-4 in the 1st through 4th non-volatile memory devices 2100-1, 2100-2, 2100-3 and 2100-4. Therefore, as illustrated in FIG. 30, 1st and 2nd logical page data LPD1_{—}1 and LPD1_{—}2 included in the 1st parity group PARITY GROUP1 may be stored in 1st level logical page L1, and 3rd and 4th logical page data LPD1_{—}3 and LPD1_{—}4 included in the 1st parity group PARITY GROUP1 may be stored in 4th level logical page L4. Similarly, 1st and 2nd logical page data LPD2_{—}1 and LPD2_{—}2 included in the 2nd parity group PARITY GROUP2 may be stored in 2nd level logical page L2, and 3rd and 4th logical page data LPD2_{—}3 and LPD2_{—}4 included in the 2nd parity group PARITY GROUP2 may be stored in 3rd level logical page L3. Similarly, 1st and 2nd logical page data LPD3_{—}1 and LPD3_{—}2 included in the 3rd parity group PARITY GROUP3 may be stored in 3rd level logical page L3, and 3rd and 4th logical page data LPD3_{—}3 and LPD3_{—}4 included in the 3rd parity group PARITY GROUP3 may be stored in 2nd level logical page L2. Similarly, 1st and 2nd logical page data LPD4_{—}1 and LPD4_{—}2 included in the 4th parity group PARITY GROUP4 may be stored in 4th level logical page L4, and 3rd and 4th logical page data LPD4_{—}3 and LPD4_{—}4 included in the 4th parity group PARITY GROUP4 may be stored in 1st level logical page L1.

In similar manner, the control unit 2210 may determine 2nd through 7th physical page groups PPG2 to PPG7 by selecting one physical page in an order from a physical page coupled to a 2nd word line WL2 to a physical page coupled to a 7th word line WL7 from the 1st and the 2nd non-volatile memory devices 2100-1 and 2100-2 and selecting one physical page in an order from a physical page coupled to a 7th word line WL7 to a physical page coupled to a 2nd word line WL2 from the 3rd and the 4th non-volatile memory device 2100-3 and 2100-4, and store four (4) sets of the 1st through 4th logical page data LPDi_1˜LPDi_4 in the 1st through 4th physical pages, respectively, included in a corresponding physical page group.

Then, the control unit 2210 may determine an 8th physical page group PPG8 by selecting a physical page coupled to an 8th word line WL8 from the 1st and the 2nd non-volatile memory devices 2100-1 and 2100-2 and selecting a physical page coupled to a 1st word line WL1 from the 3rd and the 4th non-volatile memory device 2100-3 and 2100-4, and store four (4) sets of the 1st through 4th logical page data LPD29_{—}1˜LPD29_{—}4, LPD30_{—}1˜LPD30_{—}4, LPD31_{—}1˜LPD31_{—}4 and LPD32_{—}1˜LPD32_{—}4, which are included in 29th through 32nd parity groups PARITY GROUP 29, PARITY GROUP 30, PARITY GROUP 31 and PARITY GROUP 32 and stored in the 1st through 4th physical page buffers 2240-1, 2240-2, 2240-3 and 2240-4, respectively, in the 1st through 4th physical pages, respectively, included in the 8th physical page group PPG8.

As described above, when each of the 1st through Nth non-volatile memory devices 2100-1, 2100-2, . . . , 2100-n includes the 3D flash memory cell array 2110a having multi-level cells, the SSD 2000 may store the 1st through Nth logical page data LPDi_1˜LPDi_n included in the same parity group and dispersed across logical pages of different levels as well as being dispersed across physical pages coupled to word lines at different heights in a memory cell array. Therefore, the data recovery rate imbalance between parity groups decreases and overall data recovery rate of the SSD 2000 increases.

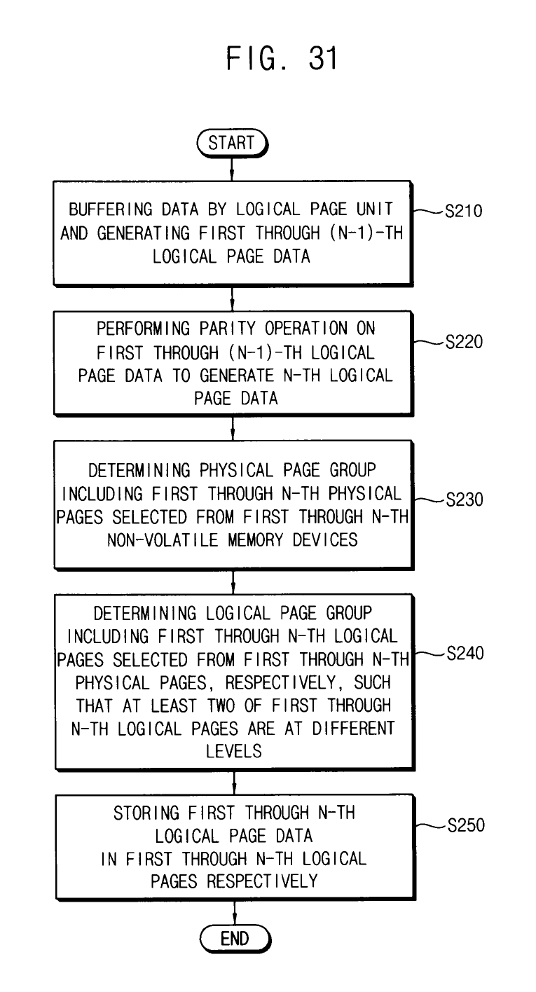

FIG. 31 is a flow chart summarizing a method of programming data in the SSD of FIG. 14.

Referring to FIG. 31, the SSD 2000 buffers data received from the host on a logical page basis and generates the 1st through (N−1)th logical page data LPDi_1˜LPDi_(n−1) (S210). The SSD 2000 performs the parity operation on the 1st through the (N−1)th logical page data LPDi_1˜LPDi_(n−1) to generate the Nth logical page data LPDi_n, which is a parity data for the 1st through the (N−1)th logical page data LPDi_1˜LPDi_(n−1) (S220). The 1st through Nth logical page data LPDi_1˜LPDi_n may constitute a parity group. The SSD 2000 determines a physical page group including 1st through Nth physical pages that are selected from the 1st through Nth non-volatile memory devices 2100-1, 2100-2, . . . , 2100-n, respectively (S230). The SSD 2000 determines a logical page group including 1st through Nth logical pages that are selected from the 1st through Nth physical pages, respectively, included in the same physical page group such that at least two of the 1st through Nth logical pages are at different levels in the constituent memory cell array (S240). In some example embodiments, each of the 1st through Nth logical pages included in the same logical page group may be one of two different levels. The SSD 2000 stores the 1st through Nth logical page data LPDi_1˜LPDi_n, which are included in the same parity group, in the 1st through Nth logical pages, respectively, included in the logical page group (S250). For example, the SSD 2000 may store the 1st logical page data LPDi_1 in the 1st logical page selected from the 1st physical page included in the 1st non-volatile memory device 2100-1, store the 2nd logical page data LPDi_2 in the 2nd logical page selected from the 2nd physical page included in the 2nd non-volatile memory device 2100-2, and store the Nth logical page data LPDi_n in the Nth logical page selected from the Nth physical page included in the Nth non-volatile memory device 2100-n.

The method of programming data in a SSD described above with reference to FIG. 31 may be performed by the SSD 2000 of FIG. 14. The structure and operation of the SSD 2000 of FIG. 14 have been described above with reference to FIGS. 14 to 30. Therefore, a detailed description of steps in FIG. 31 will be omitted here.

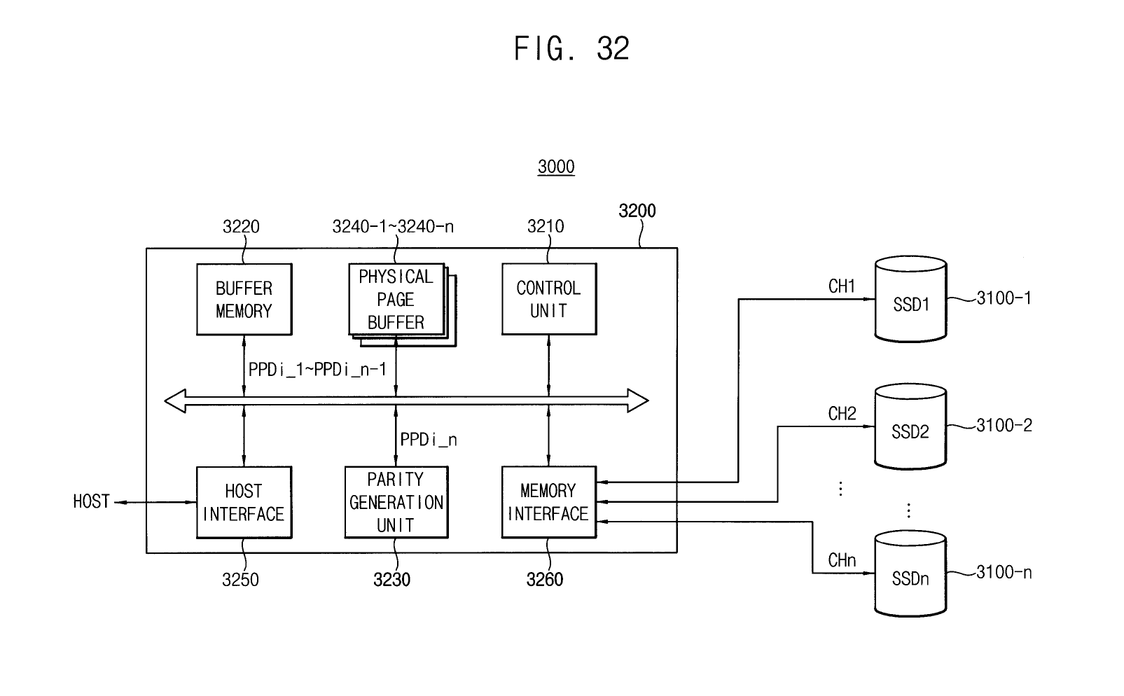

FIG. 32 is a block diagram illustrating a storage device according to still other example embodiments.

Referring to FIG. 32, a storage device 3000 includes 1st through Nth solid state drive (SSD) SSD1, SSD2, . . . , SSDn 3100-1, 3100-2, . . . , 3100-n and a redundant array of independent disks (RAID) controller 3200.

The storage device 3000 may be connected to a host, such as a laptop computer, a personal computer, a mobile device, a digital camera, etc., to be used as a storage device.

Each of the 1st through Nth non-volatile memory devices 3100-1, 3100-2, . . . , 3100-n includes a non-volatile memory device. The non-volatile memory device may include a three-dimensional (3D) flash memory cell array that is formed on a substrate in a 3D or vertical structure.

The RAID controller 3200 may include a control unit 3210, a buffer memory 3220, a parity generation unit 3230, 1st through Nth physical page buffers 3240-1, 3240-2, . . . , 3240-n, a host interface 3250, and a memory interface 3260.

Comparing the storage device 3000 of FIG. 32 with the SSD 1000 of FIG. 1, the storage device 3000 has the same structure as the SSD 1000 except that the storage device 3000 includes the 1st through Nth SSD 3100-1, 3100-2, . . . , 3100-n whereas the SSD 1000 includes the 1st through Nth non-volatile memory devices 1100-1, 1100-2, . . . , 1100-n. That is, the plurality of SSDs 3100-1, 3100-2, . . . , 3100-n constitutes the storage device 3000 with a RAID structure in FIG. 32 whereas the plurality of non-volatile memory devices 1100-1, 1100-2, . . . , 1100-n constitutes the SSD 1000 with a RAID structure in FIG. 1. The structure and operation of the SSD 1000 of FIG. 1 have been described above with reference to FIGS. 1 to 11. Therefore, duplicated description for the storage device 3000 will be omitted here.

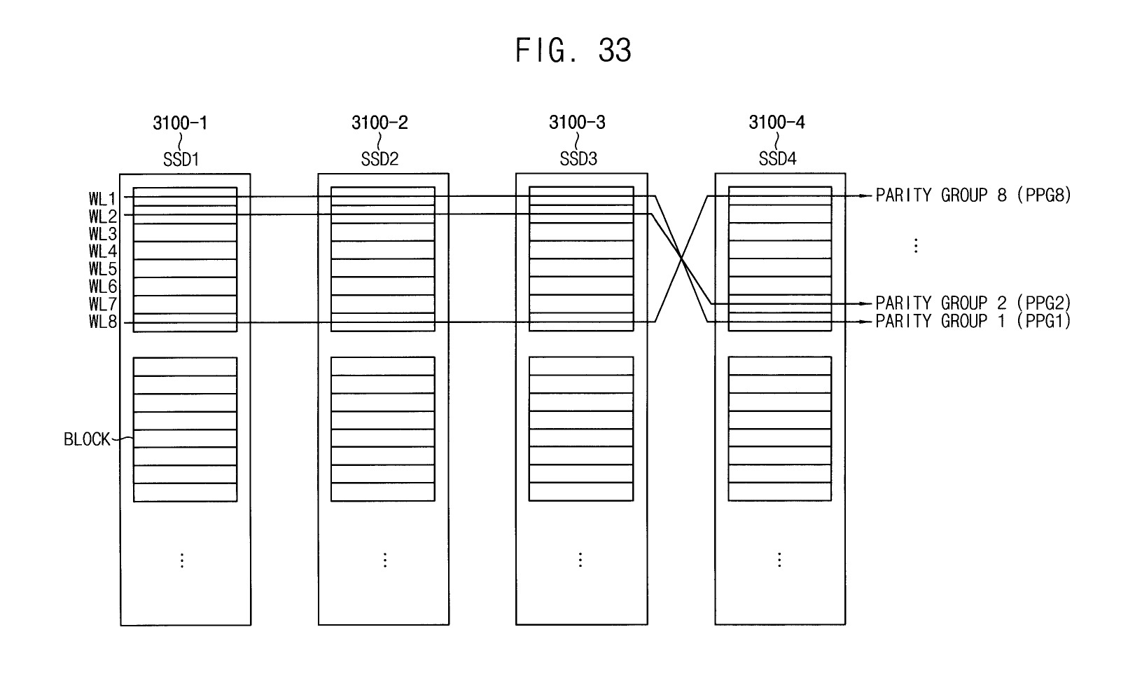

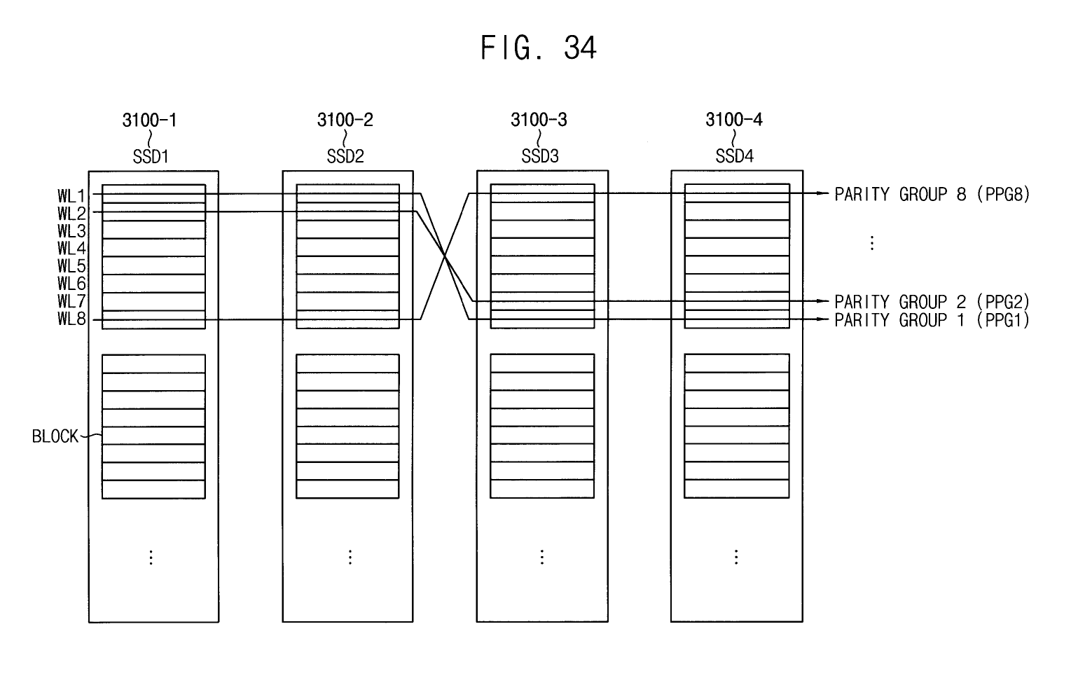

FIGS. 33 and 34 are diagrams further illustrating operation of the storage device of FIG. 32.

In FIGS. 33 and 34, the storage device 3000 includes 1st through 4th SSDs 3100-1, 3100-2, 3100-3 and 3100-4 (again N is assumed to be four) and the 3D flash memory cell array included in each of the 1st through 4th SSDs 3100-1, 3100-2, 3100-3 and 3100-4 includes a plurality of memory blocks coupled to 1st through 8th word lines WL1 to WL8 as an example.

Hereinafter, operation of the storage device 3000 will be described with reference to FIGS. 32, 33 and 34.

The buffer memory 3220 may buffer data received from the host on a physical basis in order to generate the 1st through (N−1)th physical page data PPDi_1˜PPDi_(n−1). The parity generation unit 3230 may generate the Nth physical page data PPDi_n by performing the parity operation on the 1st through the (N−1)th physical page data PPDi_1˜PPDi_(n−1). The 1st through Nth physical page data PPDi_1˜PPDi_n may constitute a parity group. The 1st through Nth physical page buffers 3240-1, 3240-2, . . . , 3240-n may store the 1st through Nth physical page data PPDi_1˜PPDi_n, which are included in the parity group, respectively.

The control unit 3210 may determine a physical page group including 1st through Nth physical pages. The 1st through Nth physical pages may be selected from the 1st through Nth SSDs 3100-1, 3100-2, . . . , 3100-n, respectively, such that at least two (2) of the 1st through Nth physical pages have different bit error rates (BERs). For example, the control unit 3210 may determine a plurality of the physical page groups by selecting one physical page in an order from a physical page coupled to a lowest word line WL1 to a physical page coupled to a highest word line WL8 from the substrate from at least one of the 1st through Nth SSDs 3100-1, 3100-2, . . . , 3100-n and selecting one physical page in an order from a physical page coupled to the highest word line WL8 to a physical page coupled to the lowest word line WL1 from a remainder of the 1st through Nth SSDs 3100-1, 3100-2, . . . , 3100-n.

In some example embodiments, as illustrated in FIG. 33, the control unit 3210 may determine a plurality of the physical page groups PPG1 to PPG8 by selecting one physical page in an order from a physical page coupled to a lowest word line WL1 to a physical page coupled to a highest word line WL8 from the 1st, 2nd and 3rd SSDs 3100-1, 3100-2 and 3100-3 and selecting one physical page in an order from a physical page coupled to the highest word line WL8 to a physical page coupled to the lowest word line WL1 from the 4th SSD 3100-4.

In this case, the control unit 3210 may determine a 1st physical page group PPG1 by selecting a physical page coupled to a 1st word line WL1 from the 1st, 2nd and 3rd SSDs 3100-1, 3100-2 and 3100-3 and selecting a physical page coupled to an 8th word line WL8 from the 4th SSD 3100-4, and then store the 1st through 4th physical page data PPD1_{—}1˜PPD1_{—}4, which are included in a 1st parity group PARITY GROUP 1 and stored in the 1st through 4th physical page buffers 3240-1, 3240-2, 3240-3 and 3240-4, respectively, in the 1st through 4th physical pages, respectively, included in the 1st physical page group PPG1.

Then, the control unit 3210 may determine a 2nd physical page group PPG2 by selecting a physical page coupled to a 2nd word line WL2 from the 1st, 2nd and 3rd SSDs 3100-1, 3100-2 and 3100-3 and selecting a physical page coupled to a 7th word line WL7 from the 4th SSD 3100-4, and then store the 1st through 4th physical page data PPD2_{—}1˜PPD2_{—}4, which are included in a 2nd parity group PARITY GROUP 2 and stored in the 1st through 4th physical page buffers 3240-1, 3240-2, 3240-3 and 3240-4, respectively, in the 1st through 4th physical pages, respectively, included in the 2nd physical page group PPG2.

In similar manner, the control unit 3210 may determine an 8th physical page group PPG8 by selecting a physical page coupled to the 8th word line WL8 from the 1st, the 2nd and the 3rd SSDs 3100-1, 3100-2 and 3100-3 and selecting a physical page coupled to the 1st word line WL1 from the 4th SSD 3100-4, and then store the 1st through 4th physical page data PPD8_{—}1˜PPD8_{—}4, which are included in an 8th parity group PARITY GROUP 8 and stored in the 1st through 4th physical page buffers 3240-1, 3240-2, 3240-3 and 3240-4, respectively, in the 1st through 4th physical pages, respectively, included in the 8th physical page group PPG8.

In other example embodiments, as illustrated in FIG. 34, the control unit 3210 may determine a plurality of the physical page groups PPG1 to PPG8 by selecting one physical page in an order from a physical page coupled to a lowest word line WL1 to a physical page coupled to a highest word line WL8 from the 1st and 2nd SSDs 3100-1 and 3100-2 and selecting one physical page in an order from a physical page coupled to the highest word line WL8 to a physical page coupled to the lowest word line WL1 from the 3rd and the 4th SSDs 3100-3 and 3100-4.

In this case, the control unit 3210 may determine the 1st physical page group PPG1 by selecting a physical page coupled to the 1st word line WL1 from the 1st and the 2nd SSDs 3100-1 and 3100-2 and selecting a physical page coupled to the 8th word line WL8 from the 3rd and the 4th SSDs 3100-3 and 3100-4, and then store the 1st through 4th physical page data PPD1_{—}1˜PPD1_{—}4, which are included in the 1st parity group PARITY GROUP 1 and stored in the 1st through 4th physical page buffers 3240-1, 3240-2, 3240-3 and 3240-4, respectively, in the 1st through 4th physical pages, respectively, included in the 1st physical page group PPG1. After that, the control unit 3210 may determine the 2nd physical page group PPG2 by selecting a physical page coupled to the 2nd word line WL2 from the 1st and the 2nd SSDs 3100-1 and 3100-2 and selecting a physical page coupled to the 7th word line WL7 from the 3rd and the 4th SSDs 3100-3 and 3100-4, and then store the 1st through 4th physical page data PPD2_{—}1˜PPD2_{—}4, which are included in the 2nd parity group PARITY GROUP 2 and stored in the 1st through 4th physical page buffers 3240-1, 3240-2, 3240-3 and 3240-4, respectively, in the 1st through 4th physical pages, respectively, included in the 2nd physical page group PPG2. In the similar way, the control unit 3210 may determine the 8th physical page group PPG8 by selecting a physical page coupled to the 8th word line WL8 from the 1st and the 2nd SSDs 3100-1 and 3100-2 and selecting a physical page coupled to the 1^{st} word line WL1 from the 3rd and 4th SSDs 3100-3 and 3100-4, and then store the 1st through 4th physical page data PPD8_{—}1˜PPD8_{—}4, which are included in the 8th parity group PARITY GROUP 8 and stored in the 1st through 4th physical page buffers 3240-1, 3240-2, 3240-3 and 3240-4, respectively, in the 1st through 4th physical pages, respectively, included in the 8th physical page group PPG8.

As described above, the storage device 3000 determines the physical page group including the 1st through Nth physical pages, such that at least two of the 1st through Nth physical pages included in the physical page group are coupled to word lines of different heights in the memory cell array, and stores the 1st through Nth physical page data PPDi_1˜PPDi_n included in the same parity group in the 1st through Nth physical pages included in the physical page group, respectively. Therefore, the data recovery rate imbalance between parity groups may be decreased, and the number of times the storage device 3000 may not be able to recover damaged data may also be decreased.

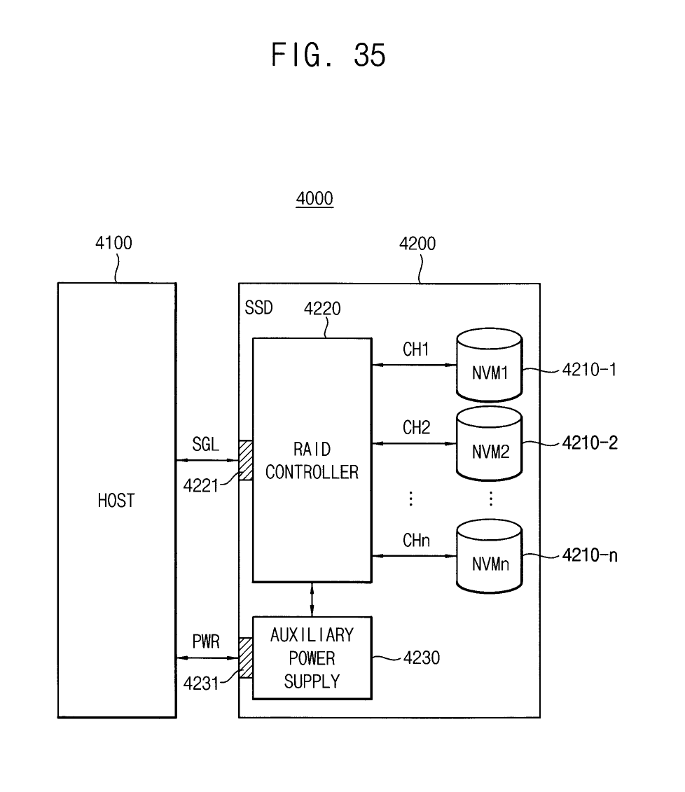

FIG. 35 is a block diagram illustrating a solid state drive (SSD) system according to example embodiments. In FIG. 35, a SSD system 4000 generally includes a host 4100 and a SSD 4200.

The SSD 4200 includes 1st through Nth non-volatile memory devices NVM1, NVM2, . . . , NVMn 4210-1, 4210-2, . . . , 4210-n and a redundant array of independent disks (RAID) controller 4220.

Each of the 1st through Nth non-volatile memory devices 4210-1, 4210-2, . . . , 4210-n may be implemented by a flash memory device. The 1st through Nth non-volatile memory devices 4210-1, 4210-2, . . . , 4210-n may be used as a storage medium.

The RAID controller 4220 is respectively coupled to the 1st through Nth non-volatile memory devices 4210-1, 4210-2, . . . , 4210-n via 1st through Nth channels CH1, CH2, . . . , CHn.

The RAID controller 4220 may exchange a signal SGL with the host 4100 through a signal connector 4221. The signal SGL may include a command, an address and data. The RAID controller 4220 may perform a program operation and a read operation on the 1st through Nth non-volatile memory devices 4210-1, 4210-2, . . . , 4210-n according to the command received from the host 4100.

The SSD 4200 may further include an auxiliary power supply 4230. The auxiliary power supply 4230 may receive power PWR from the host 4100 through a power connector 4231 and provide power to the RAID controller 4220. The auxiliary power supply 4230 may be placed inside or outside the SSD 4200. For example, the auxiliary power supply 4230 may be placed in a main board and provide auxiliary power to the SSD 4200.

The SSD 4200 may be embodied with the SSD 1000 of FIG. 1 or the SSD 2000 of FIG. 14. The structure and operation of the SSD 1000 of FIG. 1 and the SSD 2000 of FIG. 14 have been described above with reference to FIGS. 1 to 31. Therefore, a detail description of the SSD 4200 of FIG. 35 will be omitted.

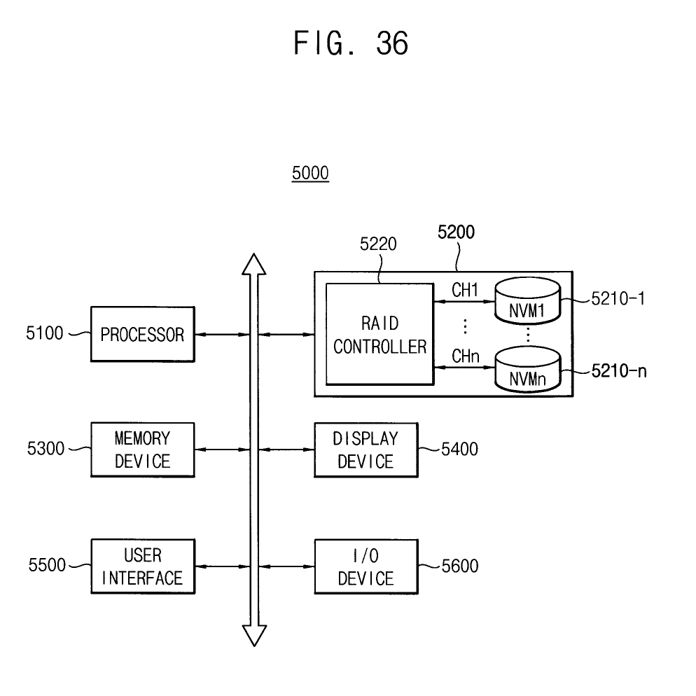

FIG. 36 is a block diagram illustrating an electronic device according to example embodiments. In FIG. 36, the electronic device 5000 generally includes a processor 5100 and a solid state drive (SSD) 5200.

The processor 5100 programs data in the SSD 5200 and reads data from the SSD 5200. The processor 5100 may perform various computing functions, such as executing specific software for performing specific calculations or tasks. For example, the processor 5100 may be a microprocessor or a central process unit. The processor 5100 may be connected to the SSD 5200 via bus such as an address bus, a control bus or a data bus, etc. The processor 5100 may be connected to an extended bus, such as peripheral component interconnect (PCI) bus.

The processor 5100 may be embodied as a single core architecture or a multi core architecture. For example, the processor 5100 may be embodied as a single core architecture when an operating frequency of the processor 5100 is less than 1 GHz, and the processor 5100 may be embodied as a multi core architecture when an operating frequency of the processor 5100 is greater than 1 GHz. The processor 5100 that is embodied as a multi core architecture may communicate with the SSD 5200 via an advanced extensible interface (AXI) bus.

The SSD 5200 performs a program operation, a read operation, and an erase operation under control of the processor 5100. The SSD 5200 includes 1st through Nth non-volatile memory devices NVM1, . . . , NVMn 5210-1, . . . , 5210-n and a redundant array of independent disks (RAID) controller 5220. The RAID controller 5220 is coupled to the 1st through Nth non-volatile memory devices 5210-1, . . . , 5210-n by 1st through Nth channels CH1, CH2, . . . , CHn, respectively.

The SSD 5200 may be embodied with the SSD 1000 of FIG. 1 or the SSD 2000 of FIG. 14. The structure and operation of the SSD 1000 of FIG. 1 and the SSD 2000 of FIG. 14 have been described above with reference to FIGS. 1 to 31. Therefore, a detail description of the SSD 5200 of FIG. 36 will be omitted.

The electronic device 5000 may further include a memory device 5300, a display device 5400, a user interface 5500 and an input/output device 5600. Although not illustrated in FIG. 36, the electronic device 5000 may further include ports to communicate with a video card, a sound card, a memory card, a universal serial bus (USB) device, etc.

The memory device 5300 may store data for operations of the electronic device 5000. The memory device 5300 may include at least one volatile memory device such as a dynamic random access memory (DRAM) device, a static random access memory (SRAM) device, etc. and/or at least one non-volatile memory device such as an erasable programmable read-only memory (EPROM) device, an electrically erasable programmable read-only memory (EEPROM) device, a flash memory device, etc.

The display device 5400 may display data stored in the SSD 5200. For example, when the SSD 5200 stores multimedia data, the processor 5100 may read the multimedia data from the SSD 5200 and generate video data by decoding the multimedia data, and the display device 5400 may display the video data. The display device 5400 may include any type of devices such as an organic light emitting display (OLED) device, a liquid crystal display (LCD) device, etc.

The user interface 5500 may include devices required for a user to control the electronic device 5000. The input/output device 5600 may include at least one input device (e.g., a keyboard, keypad, a mouse, a touch screen, etc.) and/or at least one output device (e.g., a printer, a speaker, etc.).

The electronic device 5000 may comprise any of several types of electronic devices, such as a mobile device, a smart phone, a cellular phone, a personal digital assistant (PDA), a desktop computer, a laptop computer, a work station, a personal media player (PMP), a digital camera, or the like.

The foregoing example embodiments are illustrative of the inventive concept and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to fall within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A solid state drive (SSD), comprising:
1st through Nth non-volatile memory devices each including a memory cell array, the memory cell array including a plurality of physical pages; and
a redundant array of independent disks (RAID) controller configured to perform a parity operation on 1st through (N−1)th physical page data to generate Nth physical page data, determine a physical page group including 1st through Nth physical pages respectively selected from the 1st through Nth non-volatile memory devices, such that at least two of the 1st through Nth physical pages have different bit error rates, and store the 1st through Nth physical page data in the 1st through Nth physical pages, respectively.

2. The SSD of claim 1, wherein the memory cell array is a three-dimensional (3D) memory cell array formed on a substrate,
the plurality of physical pages are respectively coupled to a plurality of word lines arranged in order in the 3D memory cell array, and
each one of the plurality of word lines defines a different height within the 3D memory cell array.

3. The SSD of claim 2, wherein at least two of the 1st through Nth physical pages are respectively coupled to a first word line and a second word line having different heights.

4. The SSD of claim 3, wherein at least one of the 1st through Nth physical pages is coupled to the first word line having a first height, and a remainder of the 1st through Nth physical pages are coupled to the second word line having a second height different from the first height.

5. The SSD of claim 4, wherein the RAID controller is further configured to determine a plurality of the physical page groups by selecting one physical page in an order from a physical page coupled to a lowest word line in the 3D memory cell array to a physical page coupled to a highest word line in the 3D memory cell array from at least one of the 1st through Nth non-volatile memory devices, and by selecting one physical page in an order from the at least one physical page coupled to the highest word line to a physical page coupled to the lowest word line from the remainder of the 1st through Nth non-volatile memory devices.

6. The SSD of claim 1, wherein the RAID controller comprises:
a buffer memory configured to generate the 1st through the (N−1)th physical page data by buffering data received from a host;
a parity generation unit configured to generate the Nth physical page data by performing the parity operation on the 1st through the (N−1)th physical page data; and
a control unit configured to determine the physical page group including the 1st through Nth physical pages, and to store the 1st through Nth physical page data in the 1st through Nth physical pages, respectively.

7. A solid state drive (SSD), comprising:
1st through Nth non-volatile memory devices, each including a memory cell array, each memory cell array including a plurality of physical pages, and each of the plurality of physical pages including first level through Mth level logical pages, where N and M are each integers greater than one; and
a redundant array of independent disks (RAID) controller configured to perform a parity operation on 1st through (N−1)th logical page data to generate Nth logical page data, determine a physical page group including 1st through Nth physical pages respectively selected from the 1st through Nth non-volatile memory devices, determine a logical page group including 1st through Nth logical pages respectively selected from the 1st through Nth physical pages, such that at least two of the 1st through Nth logical pages are of different levels, and store the 1st through Nth logical page data in the 1st through Nth logical pages, respectively.

8. The SSD of claim 7, wherein each of the 1st through Nth logical pages included is one of two different levels.

9. The SSD of claim 7, wherein the memory cell array is a two-dimensional (2D) array formed on a substrate, and
the plurality of physical pages included in the memory cell array are coupled to a plurality of word lines formed in order on the substrate.

10. The SSD of claim 9, wherein the 1st through Nth physical pages are respectively coupled to one of the plurality of word line.

11. The SSD of claim 9, wherein at least two of the 1st through Nth physical pages are coupled to different word lines among the plurality of word lines having different orders.

12. The SSD of claim 11, wherein the RAID controller is further configured to determine a plurality of the physical page groups by selecting one physical page in an order from a physical page coupled to a first word line to a physical page coupled to a last word line from at least one of the 1st through Nth non-volatile memory devices and selecting one physical page in an order from a physical page coupled to the last word line to a physical page coupled to the first word line from a remainder of the 1st through Nth non-volatile memory devices.

13. The SSD of claim 7, wherein the memory cell array is a three-dimensional (3D) memory cell array formed on a substrate, the plurality of physical pages included in the memory cell array are coupled to a plurality of word lines formed in order on the substrate, and each one of the plurality of word lines defines a different height within the 3D memory cell array.

14. The SSD of claim 13, wherein at least two of the 1st through Nth physical pages included in the physical page group are respectively coupled to a first word line having a first height and a second word line having a second height different from the first height.

15. The SSD of claim 7, wherein the RAID controller comprises:
a buffer memory configured to generate the 1st through the (N−1)th logical page data by buffering data received from a host;
a parity generation unit configured to generate the Nth logical page data by performing the parity operation on the 1st through the (N−1) logical page data;
1st through Nth physical page buffers configured to store the 1st through Nth logical page data, respectively, M times in consecutive order;
a level mix unit configured to select at least one of the 1st through Nth physical page buffers, and to change an order of the M logical page data stored in each of the selected physical page buffers; and
a control unit configured to determine the physical page group including the 1st through Nth physical pages, and store the M logical page data stored in each of the 1st through Nth physical page buffers in the first level through the Mth level logical pages included in each of the 1st through Nth physical pages, respectively.

16. A method of programming data in a solid state drive (SSD), comprising:
generating 1st through the (N−1)th physical page data by buffering data received from a host;
generating an Nth physical page data by performing the parity operation on the 1st through the (N−1)th physical page data;
determining a physical page group to include the 1st through Nth physical pages, such that at least two of the 1st through Nth physical pages have different bit error rates; and
storing the 1st through Nth physical page data in 1st through Nth physical pages of a memory cell array, respectively.

17. The method of claim 16, wherein the memory cell array is a three-dimensional (3D) memory cell array formed on a substrate, the plurality of physical pages are respectively coupled to a plurality of word lines arranged in order in the 3D memory cell array, and each one of the plurality of word lines defines a different height within the 3D memory cell array.

18. The method of claim 17, wherein two of the 1st through Nth physical pages are respectively coupled to a first word line and a second word line having different heights.

19. The method of claim 18, wherein at least one of the 1st through Nth physical pages is coupled to the first word line having a first height, and a remainder of the 1st through Nth physical pages are coupled to the second word line having a second height different from the first height.

20. The method of claim 19, wherein determining a physical page group to include the 1st through Nth physical pages comprises determining a plurality of the physical page groups by selecting one physical page in an order from a physical page coupled to a lowest word line in the 3D memory cell array to a physical page coupled to a highest word line in the 3D memory cell array from at least one of the 1st through Nth non-volatile memory devices, and by selecting one physical page in an order from the at least one physical page coupled to the highest word line to a physical page coupled to the lowest word line from the remainder of the 1st through Nth non-volatile memory devices.
